(19) United States
(12) Patent Application Publication
(10) Pub. No.: US 2026/0010573 A1
(43) Pub. Date: Jan. 8, 2026

(54) SYSTEM AND METHOD FOR COMPRESSING PROMPTS TO LANGUAGE MODELS FOR DOCUMENT PROCESSING

(71) Applicant: SAS Institute Inc., Cary, NC (US)

(72) Inventors: Teresa S. Jade, Cary, NC (US); Meilan Ji, Beijing (CN); Russell D. Albright, Spring Lake, MI (US)

(73) Assignee: SAS Institute Inc., Cary, NC (US)

(21) Appl. No.: 19/027,199

(22) Filed: Jan. 17, 2025

Related U.S. Application Data
(60) Provisional application No. 63/667,303, filed on Jul. 3, 2024.
(60) Provisional application No. 63/669,341, filed on Jul. 10, 2024.
(60) Provisional application No. 63/673,873, filed on Jul. 22, 2024.
(60) Provisional application No. 63/678,191, filed on Aug. 1, 2024.
(60) Provisional application No. 63/696,449, filed on Sep. 19, 2024.
(60) Provisional application No. 63/697,677, filed on Sep. 23, 2024.

(51) Int. Cl. G06F 16/93

(52) U.S. Cl. CPC G06F 16/93; G06F 16/35; G06F 40/30; G06N 20/00

(57) ABSTRACT

A data processing system and method include receiving a set of documents having unstructured data, executing the unsupervised machine learning model for outputting topics, selecting a first subset of topic terms, computing an inverse document frequency weight value for each topic term in the first subset of topic terms, computing a second weight value for each topic term in the first subset of topic terms, selecting a second subset of topic terms from the first subset of topic terms, generating a compressed representation of the set of documents from the second subset of topic terms to include in a prompt, inputting the prompt into a language model, and executing the language model based on the prompt to generate the topic label and the topic description.

### CROSS-REFERENCE TO RELATED APPLICATIONS

This application is a non-provisional of U.S. Provisional Application No. 63/667,303, filed on Jul. 3, 2024, U.S. Provisional Application No. 63/669,341, filed on Jul. 10, 2024, U.S. Provisional Application No. 63/673,873, filed on Jul. 22, 2024, U.S. Provisional Application No. 63/696,449, filed on Sep. 19, 2024, U.S. Provisional Application No. 63/678,191, filed on Aug. 1, 2024, and U.S. Provisional Application No. 63/697,677, filed on Sep. 23, 2024, the entireties of which are incorporated by reference herein.

### BACKGROUND

Topic modeling is a technique to discover the main topics or themes in a set of documents without having to manually read through each document. Topic modeling may be used in a wide range of applications. For example, topic modeling may be used to organize a set of documents, making it easy to manage, retrieve, and browse information (for example group articles on a website by topics such as healthcare, politics, fashion, etc.). Topic modeling may also be used for analyzing information. For example, topic modeling may be used to analyze customer feedback and reviews to identify trends, preferences, identifying issues, making recommendations, public opinion, etc. to enable better decision making and improve customer service. Topic modeling may be used academically to analyze a large volume of research papers, identify trends or interesting research subjects, etc. Topic modeling may be used in healthcare to analyze patient data, patient symptoms, clinical notes, etc. Topic modeling may be used in other applications as well. Topic modeling provides a tool for facilitating meaningful inferences from large volumes of unstructured data. However, current topic modeling techniques have limitations.

### SUMMARY

In accordance with at least some aspects of the present disclosure, a non-transitory computer-readable medium having computer-readable instructions stored thereon is disclosed. The computer-readable instructions when executed by a processor cause the processor to receive a set of documents from which to generate a topic label and a topic description for a topic, input the set of documents into an unsupervised machine learning model, execute the unsupervised machine learning model to output a plurality of topics for the set of the documents, each of the plurality of topics comprising a plurality of topic terms and each of the plurality of topic terms associated with a first weight value, select a first subset of topic terms for each topic of the plurality of topics, wherein the first subset of topic terms for each topic are selected from the plurality of topic terms of that topic based on the first weight value assigned to each of the plurality of topic terms of that topic, compute an inverse document frequency weight value for each topic term in the first subset of topic terms of each topic, compute a second weight value for each topic term in the first subset of topic terms based on the first weight value and the inverse document frequency weight value for that topic term, select a second subset of topic terms for each topic from the first subset of topic terms, wherein the second subset of topic terms are selected based on the second weight value of each topic term in the first subset of topic terms, generate a compressed representation of the set of documents from the second subset of topic terms of each topic to include in a prompt for each topic, input the prompt of each topic into a language model, and execute the language model based on the prompt to generate the topic label and the topic description for each topic of the plurality of topics.

In accordance with at least some other aspects of the present disclosure, a system is disclosed. The system includes a memory having computer-readable instructions stored thereon and a processor that executes the computer-readable instructions to receive a set of documents from which to generate a topic label and a topic description for a topic, input the set of documents into an unsupervised machine learning model, execute the unsupervised machine learning model to output a plurality of topics for the set of the documents, each of the plurality of topics comprising a plurality of topic terms and each of the plurality of topic terms associated with a first weight value, select a first subset of topic terms for each topic of the plurality of topics, wherein the first subset of topic terms for each topic are selected from the plurality of topic terms of that topic based on the first weight value assigned to each of the plurality of topic terms of that topic, compute an inverse document frequency weight value for each topic term in the first subset of topic terms of each topic, compute a second weight value for each topic term in the first subset of topic terms based on the first weight value and the inverse document frequency weight value for that topic term, select a second subset of topic terms for each topic from the first subset of topic terms, wherein the second subset of topic terms are selected based on the second weight value of each topic term in the first subset of topic terms, generate a compressed representation of the set of documents from the second subset of topic terms of each topic to include in a prompt for each topic, input the prompt of each topic into a language model, and execute the language model based on the prompt to generate the topic label and the topic description for each topic of the plurality of topics.

In accordance with at least some other aspects of the present disclosure, a method is disclosed. The method includes receiving, by a processor executing computer-readable instructions stored on a memory, a set of documents from which to generate a topic label and a topic description for a topic, inputting, by the processor, the set of documents into an unsupervised machine learning model, executing, by the processor, the unsupervised machine learning model for outputting a plurality of topics for the set of the documents, each of the plurality of topics comprising a plurality of topic terms and each of the plurality of topic terms associated with a first weight value, selecting, by the processor, a first subset of topic terms for each topic of the plurality of topics, wherein the first subset of topic terms for each topic are selected from the plurality of topic terms of that topic based on the first weight value assigned to each of the plurality of topic terms of that topic, computing, by the processor, an inverse document frequency weight value for each topic term in the first subset of topic terms of each topic, computing, by the processor, a second weight value for each topic term in the first subset of topic terms based on the first weight value and the inverse document frequency weight value for that topic term, selecting, by the processor, a second subset of topic terms for each topic from the first subset of topic terms, wherein the second subset of topic terms are selected based on the second weight value of each topic term in the first subset of topic terms, generating, by the processor, a compressed representation of the set of documents from the second subset of topic terms of each topic to include in a prompt for each topic, inputting, by the processor, the prompt of each topic into a language model, and executing, by the processor, the language model based on the prompt to generate the topic label and the topic description for each topic of the plurality of topics.

The foregoing summary is illustrative only and is not intended to be limiting in any way. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 illustrates a flow chart of an example of a process for generating and using a machine-learning model according to some aspects, according to embodiments of the present technology.

FIG. 12 illustrates an example of a machine-learning model as a neural network, according to embodiments of the present technology.

FIG. 13 illustrates various aspects of the use of containers as a mechanism to allocate processing, storage and/or other resources of a processing system to the performance of various analyses, according to embodiments of the present technology.

FIG. 14 illustrates a block diagram of an example topic label and description generation system, according to embodiments of the present technology.

FIG. 15 illustrates a flowchart outlining example operations of a first method of generating a topic label and topic description using the topic label and description generation system of FIG. 14, according to embodiments of the present technology.

FIG. 16 illustrates a flowchart outlining example operations of a second method of generating a topic label and topic description using the topic label and description generation system of FIG. 14, according to embodiments of the present technology, according to embodiments of the present technology.

FIG. 17 illustrates a flowchart outlining example operations of a third method of generating a topic label and topic description using the topic label and description generation system of FIG. 14, according to embodiments of the present technology, according to embodiments of the present technology.

FIG. 18 illustrates a flowchart outlining example operations of a fourth method of generating a topic label and topic description using the topic label and description generation system of FIG. 14, according to embodiments of the present technology.

FIG. 19A illustrates an example screenshot of a user interface showing topic terms generated by an existing mechanism, according to embodiments of the present technology.

FIG. 19B illustrates an example screenshot of a user interface showing a topic label and topic description generated using the topic label and description generation system of FIG. 14, according to embodiments of the present technology.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skills in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

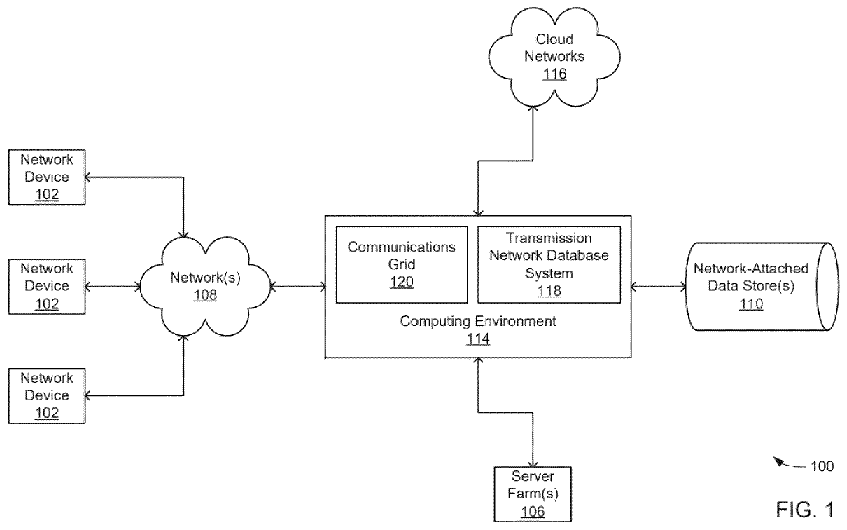

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

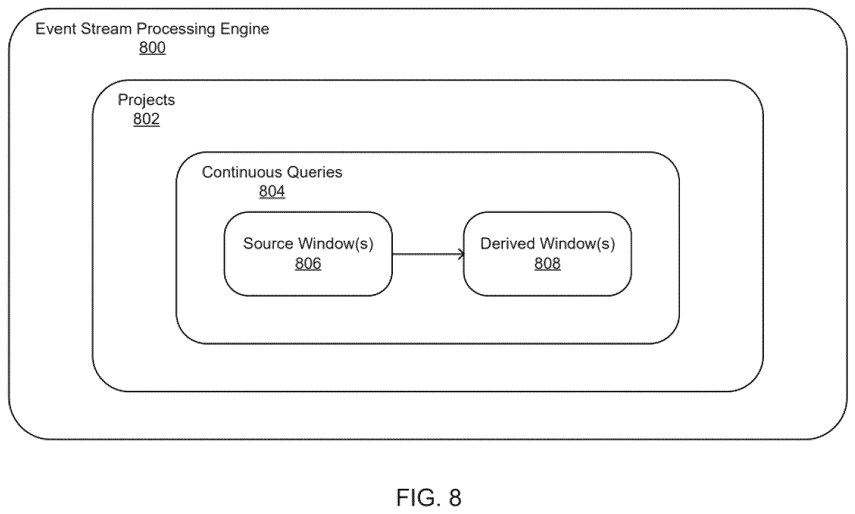

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

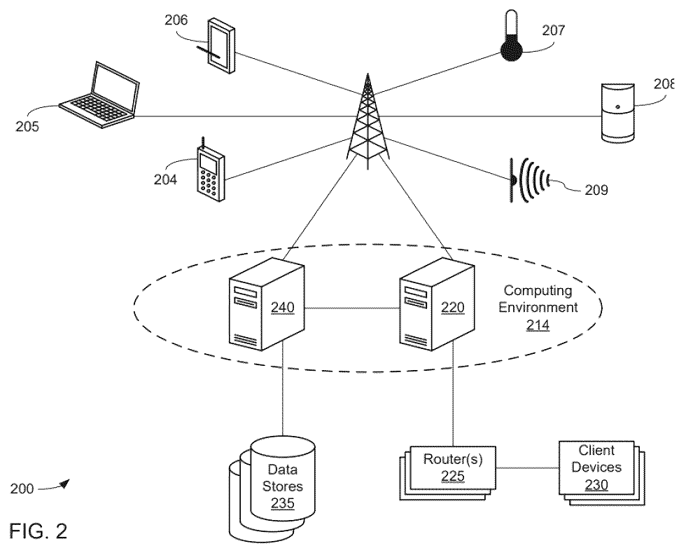

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

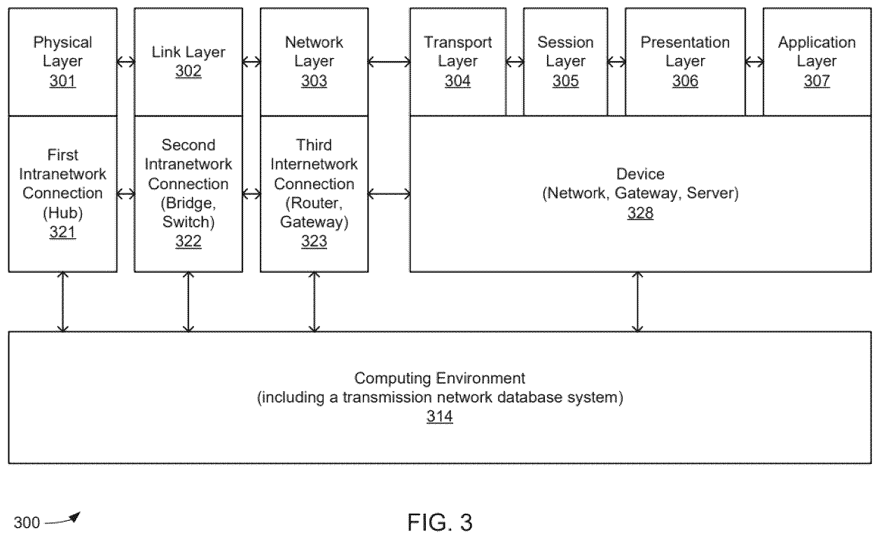

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 301. Physical layer 301 represents physical communication, and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users, and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

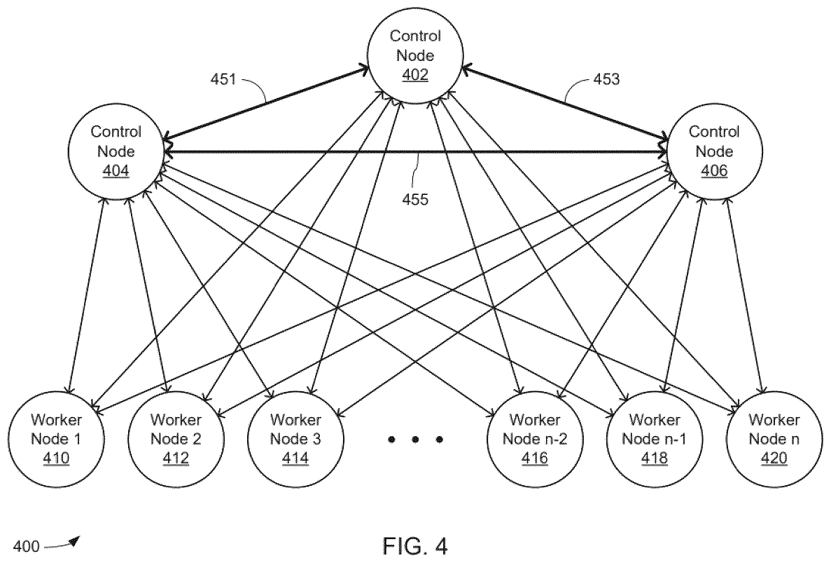

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and restart the project from that checkpoint to minimize lost progress on the project being executed.

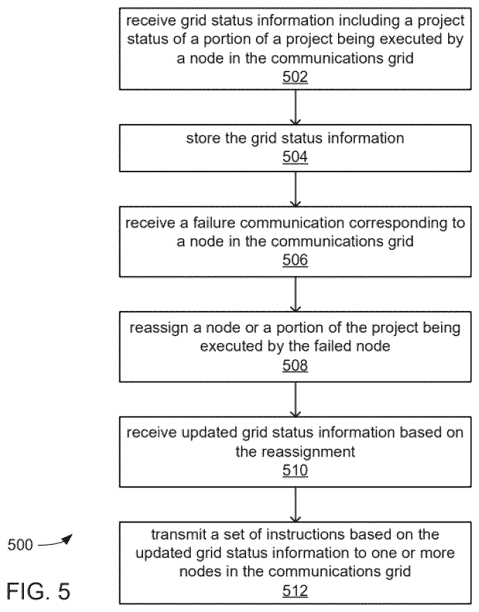

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

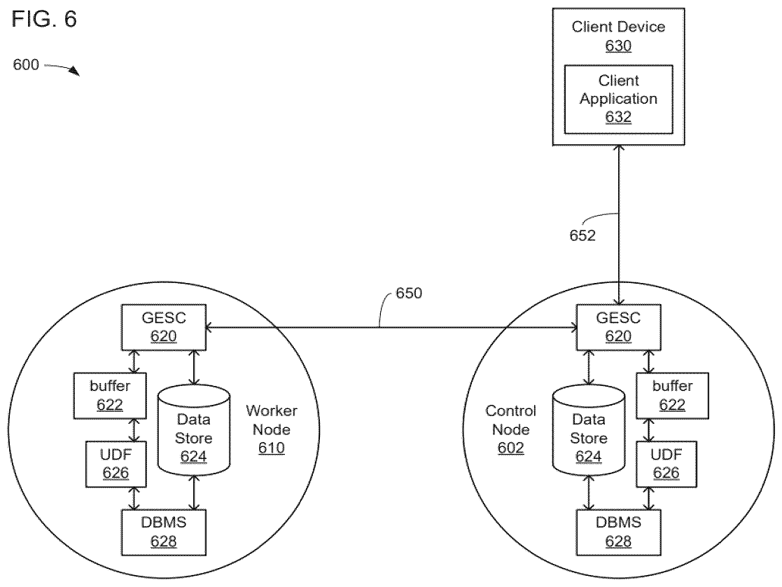

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

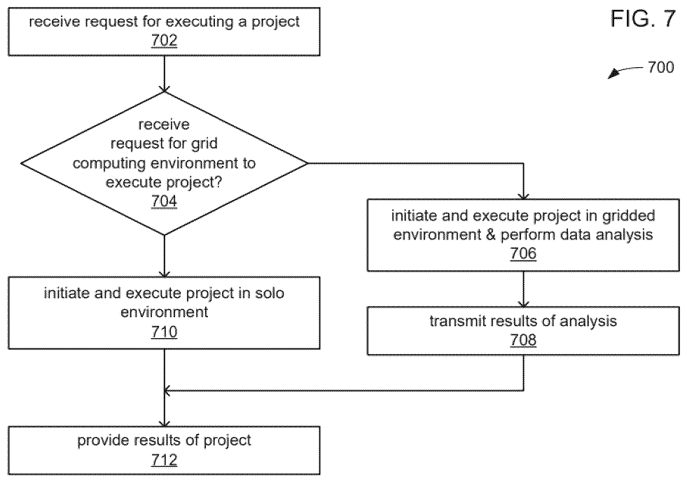

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

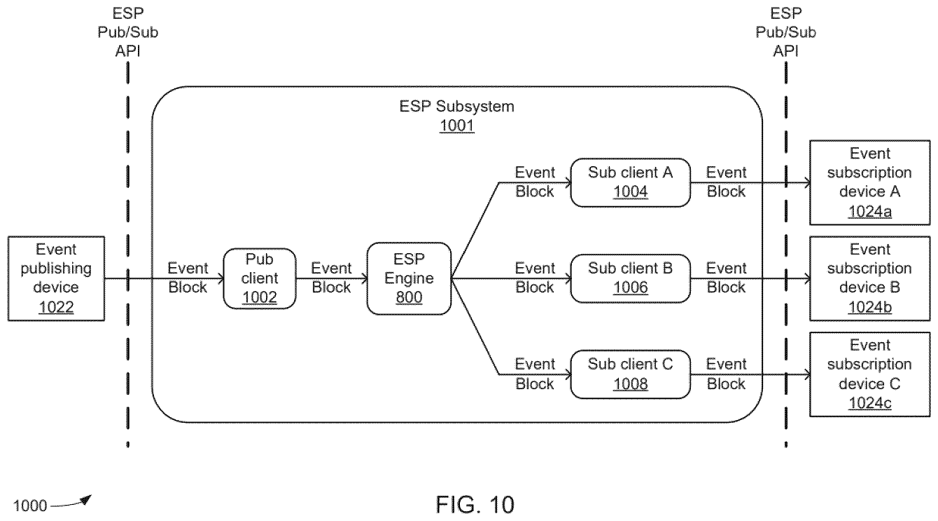

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

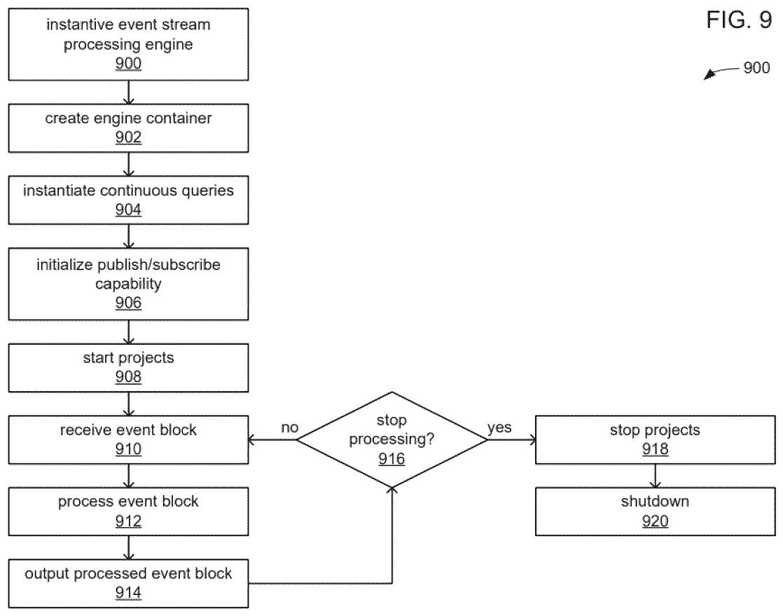

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

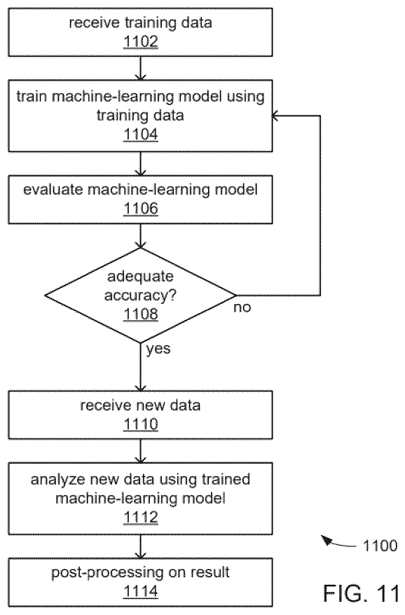

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bidirectional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these. Other networks may include transformers, large language models (LLMs), and agents for LLMs.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108, the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

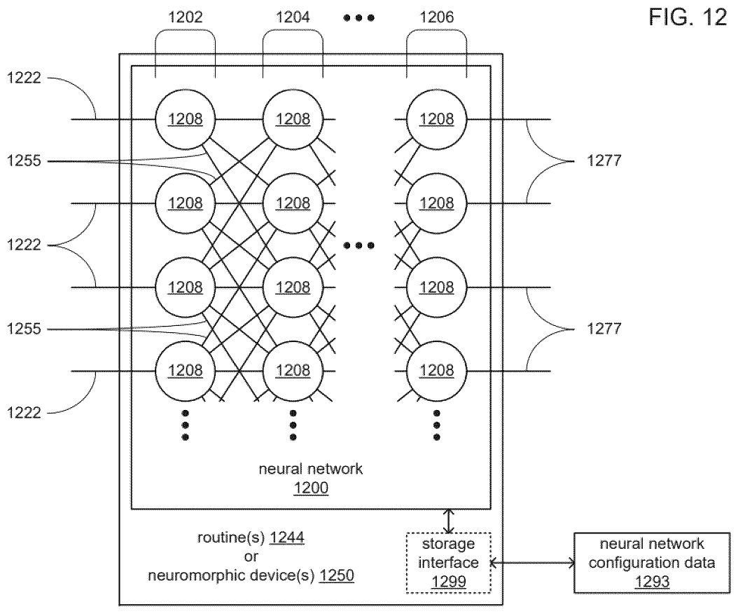

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max(x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network and/or a transformer model to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

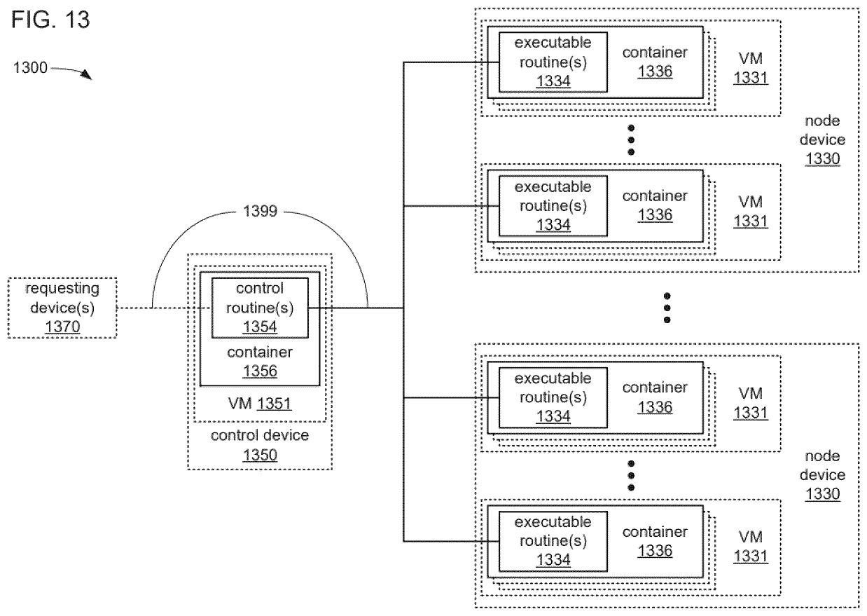

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies, and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Cloud Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively or additionally, such supporting routines may serve to provide access to one or more storage repositories (not specifically shown) in which at least data objects may be stored for use in performing the requested analyses.

The present disclosure is directed to topic modeling, and particularly to using language models such as Large Language Models (LLMs) to generate topic labels and descriptions for topics generated using topic modeling. Topic modeling is a type of statistical modeling used to discover topics within a collection of documents. Topic modeling is particularly useful for large volumes of textual data. Discovering topics in a large collection (e.g., thousands) of documents may assist with identifying themes and patterns in large sets of textual data without having to manually review and analyze the textual data. Topic modeling may also assist with identifying hidden topics that may be difficult to identify manually, particularly in a large collection of documents. Statistical topic modeling may play an important role in areas such as text mining, natural language processing, information retrieval, etc. Common topic modeling algorithms include Latent Dirichlet Allocation (LDA), Probabilistic Latent Semantic Analysis (pLSA), and Singular Value Decomposition (SVD), among others. These algorithms model sets of documents as a mixture of topics and each topic is modeled as a probability distribution over words.

In particular, topic modeling may entail inputting a set of documents into an unsupervised machine learning model, such as a topic model. The unsupervised machine learning model may implement LDA, pLSA, SVD, etc. to generate one or more topics for the set of documents. The generated one or more topics may each be defined by sets of topics terms and weights. For example, each topic may be represented by top N topic words, also referred to herein as topic terms. Each topic term may be associated with a weight value generated by the unsupervised machine learning model. These topics or associated topic terms do not have human-understandable labels or descriptions. For example, an unsupervised machine learning model may generate one or more topics for a set of documents as follows:
Topic 1: wherein, second, first, surface, mirror
Topic 2: vehicle, control, wheel, unit, driving
Topic 3: said, wherein, second, first, vehicle

In the examples above, the unsupervised machine learning model generates three topics: Topic 1, Topic 2, and Topic 3. Each of these topics is represented by top five topic terms in the example above. For example, Topic 1's topic terms are “wherein, second, first, surface, mirror,” Topic 2's topic terms are “vehicle, control, wheel, unit, driving,” and Topic 3's topic terms are “said, wherein, second, first, vehicle.” Although only five top topic terms are shown in the example above, the number of topics terms that the unsupervised machine learning model generates for each topic may be configurable.

As seen from the example above, the topics or the topic terms are not human-understandable in that by looking at the topic or the topic terms, a reader is not able to readily determine what the topic is about. Although the topic term distributions may sometimes be intuitively meaningful, it may be difficult for a human to interpret the meaning of each topic from the list of words alone. Users may have more success interpreting the meaning of each topic if they are intimately familiar with the set of documents or the application domain that the set of documents come from. However, this places an unnecessary burden on the users and somewhat defeats the purpose of topic modeling. Further, as seen in the example above, the same words may be used to define more than one topic, leading to a potentially confusing overlap between topics. For example, from simply looking at the topic terms in Topics 1 and 3 above, the differences between those topics are not clear. The problem is that these lists of words can be confusing and even misleading, and it is difficult for a human to understand the groupings of documents from these cryptic labels. Thus, existing mechanisms are limited in their scope and have limited usefulness. Because these topics and topic terms are difficult for a human to characterize or understand, there is a need for an improved topic modeling mechanism that generates a clear, concise, and accurate topic label and topic description for a topic.

Some developments attempted to overcome the above challenges by using phrases or concepts to label the topics/topic terms. Such phrases or concepts may still be very short and may not be sufficient to characterize the set of documents found in the topic. Further, the understandability of a topic may be dependent upon the quality of the phrase or concept being used to label the topic. Moreover, such labeling may require significant manual time and effort.

Some other developments attempted to overcome these challenges by putting lists of topic terms into a prompt to a Large Language Model (LLM) to represent the topic. While LLMs may be useful tools for such generative tasks, however, there are two problems to overcome. The first problem is that putting all the text of all the documents in a topic grouping into an LLM to ask the LLM to generate a label and description based on the contents may be very expensive because most LLM services charge users based upon token counts. These counts apply to both the input (prompt) and the output (response) of the LLM, so limiting both may save money. The second and bigger issue is that LLMs have a context window that limits the total number of tokens (e.g., words) allowed in both the prompt and the response. Many documents contain too much text for an LLM to handle. Thus, blanket inputting of the entire set of documents into an LLM to generate topics is not feasible.

To get around the context window limitation, some techniques have emerged that modify/truncate/limit the input into the LLM. For example, one technique inputs only the top 20 topic terms from each topic (Top 20 terms) into the LLM. Another technique inputs the top 20 topic terms from each topic plus 4 top documents (Top 20+4) into the LLM. A third technique inputs the top 500 topic terms from each topic (Top 500 terms). While these solutions overcome the context window limitation of the LLMs, these solutions may not generate a very accurate result. For example, by limiting the amount of information being input into the LLM, these methods may miss important topic terms or documents that may be more relevant. Further, these techniques may rely on the weight value that is associated with each topic term. These weight values may be automatically generated by the unsupervised machine learning model. However, these weight values may not always be representative of the importance of a term across the set of documents. For example, in the Topic 1 example above, if the topic term “wherein” has a higher weight value than the topic term “vehicle” and the weight value of the term “vehicle” is low enough to not be within the top 50 topic terms, the term “vehicle” may be omitted. However, the term “vehicle” may be more important than the term “wherein” in creating an accurate, clear, and concise topic label and description for Topic 1.

Additionally, there are hardware challenges associated with existing methodologies. In particular, there are three main challenges when LLMs are used in long context scenarios for topic modeling: (1) higher computational costs, encompassing both financial and latency expenses; (2) longer prompts introduce irrelevant and redundant information, which can weaken LLMs' performance; and (3) LLMs exhibit position bias, also known as the “lost in the middle” issue where placement of key information within the prompt may affects LLMs' performance.

More particularly, there exists a dependency between prompt size and response rate for LLMs. For example, longer prompts may lead to memory limitations and latency issues. A longer prompt may require a longer time for the LLM to process and generate an output. Longer prompts may also require more operations to generate tokens. Thus, the longer the prompt, the longer the time needed to generate the output. In some cases, the computational costs may increase quadratically with the number of tokens in the prompt. Additionally, longer prompts may require more memory to store. Longer prompts may also mean more tokens, which again may need more memory to store, leading to memory issues and bottlenecks. Latency may be related to both memory access latency and computational bottlenecks. When more information is stored in a memory, retrieving that information from the memory may add to overall latency (e.g., due to larger cache sizes that may be needed and longer access times due to large prompts). Additionally, the increased computational requirements for processing long prompts may lead to bottlenecks in the inference pipeline. In some cases, the number of tokens in the prompt may directly impact the computational resources required by the LLM, which in turn may affect costs and latency. In general, more tokens equate to higher processing demands, resulting in increased expenses and longer response times. Therefore, longer prompts may lead to requiring extra computational costs.

Further, as discussed above, longer prompts may have topic terms that are irrelevant to a topic or redundant. However, these topic terms still need to be handled and processed by the LLM, leading to unnecessary computational costs discussed above. Further, LLMs may suffer from position bias in which the model may prioritize information based on its position within the prompt. This may lead to unexpected model failures and may negatively impact performance, robustness, and reliability of the LLM.

Thus, there are technical challenges in topic modeling that limit the scope and usability of topic modeling. The present disclosure provides technical solutions to address these technical problems. In particular, the present disclosure provides approaches that overcome the challenges of token counts (e.g., context window) through prompt compression. Prompt compression involves strategically selecting a relevant subset of text from a set of documents to represent the topic content in a prompt to an LLM. The proposed approach does not simply use a list of words or the full or truncated content of the documents themselves. The present disclosure provides four different approaches of prompt compression:
Method 1: The first method leverages the topic terms used to define the topic as input to an LLM. In other words, the output of a topic model is used as input to the LLM model in the prompt. However, unlike previously existing methods, the topic terms are re-ranked using additional information beyond the weights generated by the topic model. This method includes generating the topics from a set of documents, identifying the top N topic terms based on their automatically generated weight values from the topic model, calculating an inverse document frequency (IDF) weight value for each selected term (using each topic as a single document), multiplying the original topic weight value for each term with the IDF weight value to get a new weight, ranking the top N topic terms by the new weight, identifying the top X topic terms, concatenating the identified terms together to generate a string, inserting the string into the prompt to the LLM, and generating the topic label and description based on the prompt.
Method 2: The second method leverages snippets that are extracted by an information extraction model as input to an LLM. This method includes generating the topics from the set of documents using a topic model, executing an information extraction model over the set of documents defined by the topic to identify snippets, counting each unique snippet from the set of documents and ranking them by frequency, concatenating the top N snippets in a string with their frequencies, inserting this string into the prompt to the LLM, then generating the topic label and description.
Method 3: The third method leverages snippets that are extracted by an information extraction model as input to an LLM to generate document summaries, which are then input into another LLM to turn the summaries into a label and description. This method includes generating the topics from the set of documents, executing an information extraction model over the top N documents to identify a set of snippets from each document, using the snippets as input to an LLM and getting a document summary for each document, concatenating the list of documents summaries into a string, inserting this string into the prompt to another LLM, and generating the topic name label and description.
Method 4: The fourth method of prompt compression leverages the titles of the top N documents in the topic as input to an LLM. This method includes generating the topics from a set of documents, executing an information extraction model over the top N documents to identify a title from each document, concatenating the titles from the top documents into a string representing each topic, inserting this string into the prompt to the LLM, and generating the topic name label and description.

By compressing the prompt, the present disclosure provides technical solutions that lead to a more concise, clear, and accurate topic label and description for the topic, and therefore more understandable topics. In addition to these software improvements, compressed prompts provide hardware improvements as well. For example, by reducing the size of the prompt and by having more relevant information in the prompt, the present disclosure reduces the computational cost burden associated with existing technologies. A shorter prompt may be processed faster by the LLM. A shorter prompt may also not need as much memory to store, thereby at least alleviating or even removing memory bottlenecks, improving memory access times, reducing the number of computations to be performed (e.g., shorter prompts leading to fewer tokens that need processing), and overall increasing the performance of the LLM. The proposed approach also alleviates position bias problems in the LLM because prompts are shorter and all the information in the prompt is relevant information, thereby reducing the risk of having irrelevant information (and therefore inaccurate or unclear outputs).

The present disclosure cannot be practically performed in the human mind. Nor can it be practically performed using pen and paper. Real-world applications may have thousands or millions of documents for topic modeling. A human mind is incapable of practically analyzing the large volume of textual data to generate a clear, concise, and accurate topic label and topic description in a reasonable amount of time. The concepts of the present disclosure are not directed to any observations, evaluations, judgments, or opinions that a human mind can practically perform. Given that an unsupervised machine learning model is needed to identify the topics and an LLM is needed to generate a topic label and topic description, a computing unit is needed to perform the operations herein. Further, the present disclosure does not recite a mathematical concept but is rather based on or involves mathematical concepts. In other words, the present disclosure is not directed to mathematical relationships, any specific mathematical formulas or equations, or any particular mathematical calculations. Rather, the present disclosure is directed to systems and methods that use a novel topic modeling technique in a non-conventional manner for generating a topic label and topic description for a set of documents.

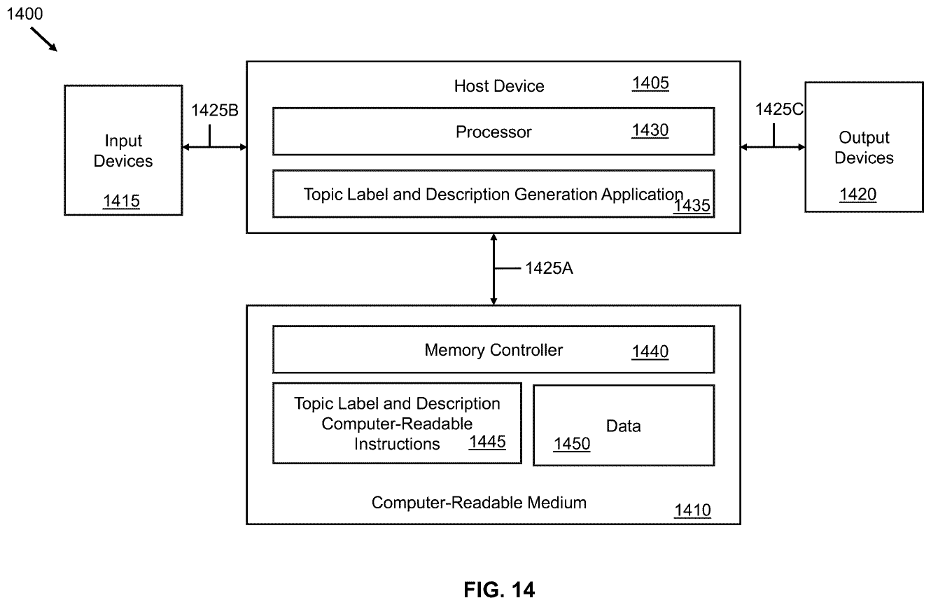

Turning now to FIG. 14, a block diagram of an example topic label and description generation system 1400 is shown, in accordance with some embodiments of the present disclosure. The topic label and description generation system 1400 may be part of, or otherwise associated with, the computing environment 114. The topic label and description generation system 1400 includes a host device 1405 associated with a computer-readable medium 1410. The host device 1405 may be configured to receive input from one or more input devices 1415 and provide output to one or more output devices 1420. The host device 1405 may be configured to communicate with the computer-readable medium 1410, the input devices 1415, and the output devices 1420 via appropriate communication interfaces, buses, or channels 1425A, 1425B, and 1425C, respectively. The topic label and description generation system 1400 may be implemented in a variety of computing devices such as computers (e.g., desktop, laptop, etc.), servers, tablets, personal digital assistants, mobile devices, wearable computing devices such as smart watches, other handheld or portable devices, or any other computing units suitable for performing operations described herein using the host device 1405.

Further, some or all of the features described in the present disclosure may be implemented on a client device, an on-premise server device, a cloud/distributed computing environment, or a combination thereof. Additionally, unless otherwise indicated, functions described herein as being performed by a computing device (e.g., the topic label and description generation system 1400) may be implemented by multiple computing devices in a distributed environment, and vice versa.

The input devices 1415 may include any of a variety of input technologies such as a keyboard, stylus, touch screen, mouse, track ball, keypad, microphone, voice recognition, motion recognition, remote controllers, input ports, one or more buttons, dials, joysticks, point of sale/service devices, card readers, chip readers, and any other input peripheral that is associated with the host device 1405 and that allows an external source, such as a user, to enter information (e.g., data) into the host device and send instructions to the host device 1405. Similarly, the output devices 1420 may include a variety of output technologies such as external memories, printers, speakers, displays, microphones, light emitting diodes, headphones, plotters, speech generating devices, video devices, and any other output peripherals that are configured to receive information (e.g., data) from the host device 1405. The “data” that is either input into the host device 1405 and/or output from the host device may include any of a variety of textual data, numerical data, alphanumerical data, graphical data, video data, sound data, position data, combinations thereof, or other types of analog and/or digital data that is suitable for processing using the Topic label and description generation system 1400.

The host device 1405 may include a processor 1430 that may be configured to execute instructions for running one or more applications associated with the host device 1405. In some embodiments, the instructions and data needed to run the one or more applications may be stored within the computer-readable medium 1410. The host device 1405 may also be configured to store the results of running the one or more applications within the computer-readable medium 1410. One such application on the host device 1405 may be a topic label and description generation application 1435. The topic label and description generation application 1435 may be used to generate a topic label and topic description for a topic.

The topic label and description generation application 1435 may be executed by the processor 1430. The instructions to execute the topic label and description generation application 1435 may be stored within the computer-readable medium 1410. To facilitate communication between the host device 1405 and the computer-readable medium 1410, the computer-readable medium may include or be associated with a memory controller 1440. Although the memory controller 1440 is shown as being part of the computer-readable medium 1410, in some embodiments, the memory controller may instead be part of the host device 1405 or another element of the topic label and description generation system 1400 and operatively associated with the computer-readable medium 1410. The memory controller 1440 may be configured as a logical block or circuitry that receives instructions from the host device 1405 and performs operations in accordance with those instructions. For example, to execute the topic label and description generation application 1435, the host device 1405 may send a request to the memory controller 1440. The memory controller 1440 may read the instructions associated with the topic label and description generation application 1435. For example, the memory controller 1440 may read topic label and description generation instructions 1445 stored within the computer-readable medium 1410 and send those instructions back to the host device 1405. In some embodiments, those instructions may be temporarily stored within a memory on the host device 1405. The processor 1430 may then execute those instructions by performing one or more operations called for by those instructions.

The computer-readable medium 1410 may include one or more memory circuits. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the computer-readable medium 1410. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The computer-readable medium 1410 may also be configured to store data 1450. The data 1450 may include an input set of documents. The data 1450 may also include a topic label and topic description generated from the input set of documents. The data 1450 may also include model descriptions and other information needed to implement and execute one or more machine learning models. The data 1450 may further include any other data or information that is needed by the topic label and description generation application 1435 to perform operations described herein.

It is to be understood that only some components of the topic label and description generation system 1400 are shown and described in FIG. 14. However, the topic label and description generation system 1400 may include other components such as various batteries and power sources, networking interfaces, routers, switches, external memory systems, controllers, etc. Generally speaking, the topic label and description generation system 1400 may include any of a variety of hardware, software, and/or firmware components that are needed or considered desirable in performing the functions described herein. Similarly, the host device 1405, the input devices 1415, the output devices 1420, and the computer-readable medium 1410, including the memory controller 1440, may include hardware, software, and/or firmware components that are considered necessary or desirable in performing the functions described herein.

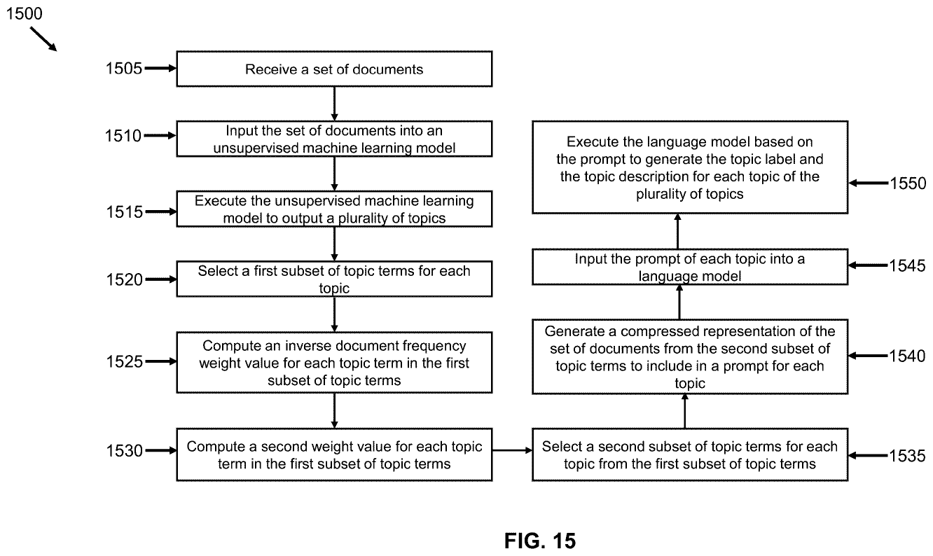

Referring now to FIG. 15, an example flowchart outlining operations of a process 1500 is shown, in accordance with some embodiments of the present disclosure. The process 1500 may be executed by one or more processors (e.g., the processor 1430) executing computer-readable instructions (e.g., the topic label and description generation instructions 1445) associated with the topic label and description generation application 1435. The process 1500 may be used for generating a topic label and topic description for a topic. The process 1500 may include other or additional operations in other embodiments. The process 1500 corresponds to Method 1 mentioned above.

At operation 1505, the processor receives a set of documents from which to generate a topic label and a topic description for a topic. In some embodiments, the set of documents may include one or more articles such as research papers, dissertations, newspapers, magazines, news, etc., customer reviews, social media posts, emails, legal documents such as contracts, patents, court filings, etc., healthcare records, books, novels, or other literary works, transcripts, reports, survey responses, and/or any type of written record from which a topic may be desired to be generated. In some embodiments, data other than written records may be used. When non-textual data is to be used, the non-textual data may be converted into textual form. For example, in some embodiments, video data, audio data, scanned data, etc. that is readily not technically textual data, may be converted into textual data for generating topics therefrom.

The number of documents in the set of documents may vary as well. In some embodiments, the number of documents in the set of documents may be dependent on the type of unsupervised machine learning model that is being used to generate topics. In some embodiments, unsupervised machine learning models may have a maximum number of tokens (e.g., documents) that they may receive as inputs (and generate as outputs). In other embodiments, the number of documents in the set of documents may vary as desired. Further, in some embodiments, the set of documents may include full documents, portions of documents, summaries of documents, snippets of documents, selected list of terms from the documents, metadata from documents, and/or a combination thereof.

At operation 1510, the processor inputs the set of documents into an unsupervised machine learning model. In some embodiments, an unsupervised machine learning model may be a type of machine learning model that is configured to analyze and find patterns or trends in data without predefined labels or categories. In some embodiments, the unsupervised machine learning model may be a topic model. A topic model may be configured to perform topic modeling. Topic modeling may be configured to discover topics in the set of documents. Topic modeling may be considered a Natural Language Processing (NLP) task. In some embodiments, the topic model may implement a Latent Dirichlet Allocation (LDA) clustering model or a Singular Value Decomposition (SVD) model. Details on the implementation of LDA may be found in Blei, Ng, Jordan “Latent Dirichlet Allocation” (2003), the entirety of which is incorporated by reference herein. Details on the implementation of SVD may be found in Deerwester, Dumais, et al. “Indexing by Latent Semantic Analysis” (1990), the entirety of which is incorporated by reference herein. In other embodiments, other suitable topic models or any other suitable unsupervised machine learning model may be used to generate topics therefrom. In some embodiments, topic modeling may work by discovering words in each document of the set of documents and grouping or clustering related or similar words together into topics. A topic may, thus, be defined as a group of reoccurring related or similar words that appear in the set of documents and that represent a common theme or subject. The set of documents may generate one or more topics.

At operation 1515, the processor executes the unsupervised machine learning model to output a plurality of topics for the set of the documents. In some embodiments, the number of topics that are generated from the unsupervised machine learning model may be specified as a user input into the unsupervised machine learning model. In some embodiments, the machine learning model may be configured to generate a minimum or maximum number of topics by default. In such instances, the unsupervised machine learning model may generate the default number of topics unless specified otherwise by the user. In some embodiments, each topic of the plurality of topics may belong to one or more documents of the set of documents. In other words, each document of the set of documents may be associated with one or more topics of the plurality of topics. For example, if 3 topics are generated from 1000 documents, topic 1 may be associated with 5 documents (e.g., 5 documents include text related to topic 1), topic 2 may be associated with all 1000 documents (e.g., all 1000 documents include text related to topic 2), and topic 3 may be associated with 500 documents (e.g., 500 documents include text related to topic 3). In some embodiments, each generated topic may include additional information associated therewith. For example, in some embodiments, each topic may identify the documents from the set of documents to which the topic belongs. For example, if a topic is only found in documents 1, 10, and 20, the topic may include an indication that the topic is found in documents 1, 10, and 20. This way, the documents to which each topic belongs may be easily identified. It is to be understood that any examples used herein are used for explanation purposes only and are not intended to limit the scope of the disclosure in any way. Thus, from the set of documents, a plurality of topics may be generated. Although the present disclosure has been described as generating a plurality of topics, in some embodiments, a single topic may be generated from the set of documents.

Each topic of the plurality of topics may include a plurality of topic terms. Topic terms are words that are representative of a particular topic. For example, for a topic related to computer technology, topic terms may be words associated with computer technology (e.g., memory, binary, bits, bytes, central processing unit, operating system, etc.). In some embodiments, the topic terms may include a predetermined number of most significant words associated with a topic. In some embodiments, the number of topic terms to generate for each topic from the unsupervised machine learning model may be provided by the user as an input. In some embodiments, the number of topic terms to generate for each topic may be preprogrammed into the unsupervised machine learning model. In some embodiments, anywhere from 10 to 300 words may be generated for each topic. Further, in some embodiments, each topic in the plurality of topics may have the same number of topic terms. In other embodiments, one or more topics of the plurality of topics may have different number of topic terms.

Further, each of the plurality of topic terms may be associated with a first weight value. The first weight value may be indicative of a relevance of a topic term to the topic. In some embodiments, relevance may be indicated by a frequency of occurrence of a topic term in the text associated with the topic. A topic term that occurs more frequently may be accorded a higher first weight value. In some embodiments, relevance may be indicated by how closely connected or related to a topic a topic term is. For example, for a computer technology topic, terms such as “computer,” “operating system,” etc. may be accorded a higher first weight value than terms like “wherein,” “machine,” etc. In some embodiments, the higher the first weight value, the higher the relevance of the topic term to the topic. In some embodiments, the first weight value may be a number between a predefined range (e.g., between 0 and 1). For example, a topic that may be generated from the unsupervised machine learning model may be as follows:
Topic 1: [(‘wherein’, 0.035438593), (‘second’, 0.017641282), (‘first’, 0.015290709), (‘surface’, 0.015077849), (‘mirror’, 0.014189651), (‘charging’, 0.014186617), (‘vehicle’, 0.014154276), (‘portion’, 0.0133547215), (‘assembly’, 0.01099547), (‘part’, 0.010697912), (‘configured’, 0.010467553), (‘comprises’, 0.010351748), (‘least’, 0.009702432), (‘front’, 0.009596409), (‘element’, 0.009579583), (‘electric’, 0.008690997), (‘one’, 0.008391646), (‘connected’, 0.008011769), (‘glass’, 0.007848864), (‘airbag’, 0.007674934), (‘guide’, 0.0075757666), (‘according’, 0.0073977057), (‘upper’, 0.0071686436), (‘end’, 0.0070889005), (‘cover’, 0.0070684035), (‘rear’, 0.006724241), (‘comprising’, 0.006545309), (‘lower’, 0.006178395), (‘position’, 0.006003768), (‘interior’, 0.005641327), (‘system’, 0.005517785), (‘drive’, 0.005471626), (‘anchor’, 0.0050566075), (‘method’, 0.004883391), (‘coupled’, 0.0048464118), (‘housing’, 0.0047474275), (‘connector’, 0.0046585733), (‘head’, 0.004484321), (‘wheel’, 0.0044364403), (‘seat’, 0.004397048), (‘plurality’, 0.004354386), (‘electrically’, 0.0042882888), (‘vehicular’, 0.004115196), (‘direction’, 0.0039428654), (‘provided’, 0.0039153094), (‘plate’, 0.0038642006), (‘module’, 0.003801667), (‘detent’, 0.0037999535), (‘link’, 0.003749748), (‘rearview’, 0.0037298477), (‘base’, 0.003690733), (‘coupling’, 0.0036362086), (‘third’, 0.0034801231), (‘substrate’, 0.003436294), (‘group’, 0.0033716357), (‘disposed’, 0.0033322084), (‘exterior’, 0.0032236509), (‘aircraft’, 0.0031926788), (‘side’, 0.0031827462), (‘fastening’, 0.003149399), (‘relative’, 0.0030285025), (‘light’, 0.0029845354), (‘formed’, 0.0029823412), (‘angle’, 0.0029793773), (‘connection’, 0.002833421), (‘motor’, 0.0027290701), (‘driver’, 0.0027190323), (‘unit’, 0.0026712024), (‘device’, 0.0026593204), (‘container’, 0.002633983), (‘fastener’, 0.002627163), (‘hook’, 0.0026098767), (‘optical’, 0.002597458), (‘linkage’, 0.0025961779), (‘gear’, 0.0024662695), (‘respective’, 0.0024055734), (‘force’, 0.0023930436), (‘reflective’, 0.002385694), (‘conductive’, 0.0023607211), (‘clip’, 0.0023038886)]

Topic 1 above includes a plurality of topic terms (e.g., wherein, second, first, surface, mirror, etc.) and each topic term is followed by a number indicative of that topic term's first weight value. The number of topic terms shown in Topic 1 above are only an example. The number of topic terms that are output may vary. In some embodiments, the topic terms in a topic may be arranged in an order from the highest weight value to the lowest weight value. In some embodiments, the unsupervised machine learning model may generate a first number (e.g., 100) of topic terms for a topic but output a second number (e.g., 20) of highest weighted topic terms. Thus, the topic term having the highest weight may be listed first and the topic term having the lowest weight may be listed last. In some embodiments, the topic terms may be arranged in the topic in another order. In some embodiments, a threshold value of the first weight value may be defined. Potential topic terms whose first weight value is below the defined threshold value may be discarded and not output as the plurality of topic terms. Thus, in some embodiments, only those potential topic terms whose first weight value is above the defined threshold value may be output as the plurality of topic terms.

Further, in some embodiments, a topic term may occur in multiple topics. In other embodiments, a topic term may occur in a single topic. When a topic term occurs in multiple topics, in some embodiments, the first weight value assigned to the topic term in each topic may vary depending upon the relevance of that topic term to that topic. Thus, the unsupervised machine learning model generates a plurality of topics from the set of documents, with each of the plurality of topics having a plurality of topic terms, and each of the plurality of topic terms being associated with a first weight value indicative of the relevance of a topic term to a topic.

At operation 1520, the processor selects a first subset of topic terms (e.g., the first 50 terms in the Topic 1 example above) for each topic. For example, in some embodiments, the processor may be configured to select N topic terms from each topic of the plurality of topics. In some embodiments, N may be a user defined or preprogrammed value. In some embodiments, N may be smaller than the number of topic terms in the plurality of topic terms. For example, if at the operation 1515, 3 topics were output, with each topic having 200 topic terms and if N=100, then at the operation 1520, the processor selects 100 terms from the 200 topic terms of each of the 3 topics as the first subset of topic terms. In some embodiments, the value of N may be the same for each topic. In some embodiments, the value of N may be different for at least one topic. In other words, in some embodiments, the same number of topic terms may be selected from each topic for the first subset of topic terms, while in some embodiments, a different number of topic terms may be selected from one or more of the topics for the first subset of topic terms.

In some embodiments, the first subset (e.g., N) of topic terms for each topic may be selected from the plurality of topic terms of that topic based on the first weight value assigned to each of the plurality of topic terms. For example, in some embodiments, the processor may be configured to select N highest weighted topic terms from the plurality of topic terms of a particular topic. In other embodiments, the processor may be configured to select N topic terms that satisfy another criterion.

At operation 1525, the processor computes an Inverse Document Frequency (IDF) weight value for each topic term in the first subset of topic terms of each topic. The IDF may be used to measure how unique or rare a topic term is across a set of topics. In some embodiments, a higher IDF weight value for a topic term may indicate that the topic term is rarer within the topics. Rare or unique terms may be used for ensuring that topics are accurately represented and easily distinguishable, thereby improving the interpretability of the topics. In some embodiments, the processor may compute the IDF weight value using:

$$I D {F}_{topicterm} = log ( \frac{total number of topics}{number of topics containing the topicterm} ) \qquad Equation 1$$

In Equation 1 above, IDF_{topicterm} is the IDF weight value for a topic term of the plurality of topic terms of a topic, total number of topics is a number of the plurality of topics, and number of topics containing the topicterm is the number of the plurality of topics that have the topic term included in the plurality of topic terms.

At operation 1530, the processor computes a second weight value for each topic term in the first subset of topic terms based on the first weight value and the IDF weight value for that topic term. By computing the second weight value, the processor considers both the frequency of the topic terms within a topic and their rarity across different topics, leading to a more focused and distinguishable representation of the topics. In some embodiments, the processor may compute the second weight value for each topic term in the first subset of topic terms of each topic by multiplying the first weight value of that topic term and the IDF weight value of that topic term. Thus, each topic term in the first subset of topic terms may have a first weight value, an IDF weight value, and a second weight value.

At operation 1535, the processor selects a second subset of topic terms for each topic from the first subset of topic terms. For example, in some embodiments, the processor may select X topic terms for each topic from the first subset of topic terms. In some embodiments, X may be a user defined or preprogrammed value. In some embodiments, X may be smaller than the number of topic terms in the plurality of topic terms. In some embodiments, a number of topic terms in the second subset of topic terms (X) may be less than the number of topic terms in the first subset of topic terms (N). In some embodiments, the number of topic terms in the second subset of topic terms may be based on a maximum number of tokens that a machine learning model may be configured to accept. For example, in some embodiments, the number of topic terms in the second subset of topic terms may be less than the maximum number of topic terms that an LLM may be configured to accept. In some embodiments, the second subset of topic terms may be selected based on the second weight value of each topic term in the first subset of topic terms. For example, in some embodiments, the X topic terms having the highest second weight value may be selected for each topic from the first subset of topic terms for that topic. Continuing the Topic 1 example above, in some embodiments, the processor may select the following topic terms as the second subset of topic terms:
Topic 1: [mirror: 0.03267, glass: 0.01807, charging: 0.013, guide: 0.01219, anchor: 0.01164, front: 0.01155, cover: 0.01138, connector: 0.01073, head: 0.01033, assembly: 0.01008, lower: 0.00994, part: 0.0098, portion: 0.00926, airbag: 0.00924, interior: 0.00908, detent: 0.00875, link: 0.00863, upper: 0.00863, rearview: 0.00859, coupling: 0.00837]

In the selected second subset of topic terms, the number after each topic term is the computed second weight value.

At operation 1540, the processor generates a compressed representation of the set of documents from the second subset of topic terms of each topic to include in a prompt for each topic. Thus, in some embodiments, the processor may generate a prompt for each topic. Thus, each prompt may be representative of multiple documents in the set of documents depending upon which documents include the topic for which the prompt is generated. Further, each document may contribute content to multiple prompts depending on the number of topics that document belongs to. For example, if a document belongs to three topics, that document may contribute content to three prompts.

In some embodiments, to generate the compressed representation of the set of documents from the second subset of topic terms, the processor may concatenate the second subset of topic terms selected at the operation 1535 to generate a string for each topic. For example, in some embodiments, the processor may concatenate the selected second subset of topic terms as follows:
Topic 1: mirror, glass, charging, guide, anchor, front, cover, connector, head, assembly, lower, part, portion, airbag, interior, detent, link, upper, rearview, coupling

In some embodiments, the second subset of topic terms may be concatenated in a specific order. For example, in some embodiments, the second subset of topic terms may be concatenated in an order from a highest second weight value to a lowest second weight value. In some embodiments, the second subset of topic terms may be concatenated in an order from a lowest second weight value to a highest weight value. In other embodiments, the second subset of topic terms may be concatenated in a random order, alphabetical order, or in any other desired order. The concatenated string provides a compressed representation of the set of documents.

Further, the prompt that is generated based on the compressed representation of the set of documents may include the concatenated string for a topic, an output definition defining a format for the topic label and the topic description for the topic, and one or more constraints. The constraints may include a system role and a user role to provide a framework for how to generate the topic label and topic description for each topic. In some embodiments, the constraints may also include a summary of what to include in the topic description. In some embodiments, the format for the topic label and the topic description may define how the result is to be presented. In some embodiments, an example format that may be used may be in the form: <topic number>: <topic label>: <topic description>. In other embodiments, the output definition may have other, additional, or different parameters in the prompt. An example of a prompt that the processor may generate for the concatenated string above may look like:

```
messages=[
  {“role”: “system”, “content”: “You are a data scientist.”},
  {“role”: “user”, “content”: “Generate concise topic names and
corresponding descriptions based on the top 20 topic words in the patent
data category VEHICLES provided in below TEXT.
```

The summary of the topic should include some illustrative concepts related to the topic and how they relate to the topic or domain.
The output in this format: topic 1: topic name: Summarize what this topic is about and its underlying clues.

/// TEXT: Topic 1: mirror, glass, charging, guide, anchor, front, cover,
connector, head, assembly, lower, part, portion, airbag, interior, detent,
link, upper, rearview, coupling :}

In the prompt above, the portion “{“role”: “system”, “content”: “You are a data scientist.”}, {“role”: “user”, “content”: “Generate concise topic names and corresponding descriptions based on the top 20 topic words in the patent data category VEHICLES provided in below TEXT”} provides an example of a constraint of a system role and a user role. The system role and the user role provide a guideline to the machine learning model for generating a topic label and topic description that is appropriate for that system role and user role. The system role provides a more general guideline to the machine learning model. For example, the system role is “You are a data scientist” in the example above. This is an instruction to the machine learning model to pretend that it is a data scientist and generate the topic label and topic description that a data scientist would generate (or that would be relevant to a data scientist). The user role provides a more specific guideline to the machine learning model. The user role in the example above is “Generate concise topic names and corresponding descriptions based on the top 20 topic words in the patent data category VEHICLES provided in below TEXT.” This guideline specifies what to generate the topic label and topic description on. The “TEXT” is the concatenated string generated from the second subset of topic terms.

The prompt above also provides a summary of what the topic description may include. In the example above, the summary indicates that the topic description “should include some illustrative concepts related to the topic and how they relate to the topic or domain.” The prompt above also provides a format in which the output is to be provided: “The output in this format: topic 1: topic name: Summarize what this topic is about and its underlying clues.”

Thus, by varying the information in the prompt, the processor may be configured to give different instructions to the machine learning model and generate different topic labels and topic descriptions from the same compressed representation of the set of documents. In some embodiments, the prompt may include other, additional, or different information.

At operation 1545, the processor inputs the prompt of each topic into a language model. In some embodiments, the language model may be a Large Language Model (LLM). Additional details about the implementation of an LLM may be found in Brown, Mann, et al. “Language Models are Few-Shot Learners” (2020), the entirety of which is incorporated by reference herein. In some embodiments, any suitable LLM may be used. In some embodiments, the language model may be a Small Language Model (SLM). In some embodiments, the language model may be a Multi-Modal Large Language Model (MLLM). In some embodiments, the language model may be another type of model that is suitable for and configured to perform the operations described herein. At operation 1550, the processor executes the language model based on the prompt to generate the topic label and the topic description for each topic of the plurality of topics. An example topic label and topic description for the example prompt above may look like the following:
Topic 1: Rearview Mirror Assembly: This topic relates to the assembly and components of a rearview mirror, including the mirror glass, connector, anchor, and cover. It also includes concepts such as the detent, link, and coupling

In the output above, the “Rearview Mirror Assembly” is the topic label (also referred to herein as topic name) and is followed by a topic description describing what the topic relates to. The topic description may provide insights into what the documents that contain that topic include.

Thus, the process 1500 provides a mechanism to generate a readable and useful label and description for all topics with minimal work to engineer a useful and concise prompt. The process 1500 uses IDF to measure how unique or rare a topic term is across a set of topics. This information, when combined with the first weight value to compute the second weight value for the topic term, provides a useful way to identify the most useful topic terms to help the language model generate the topic label and topic description for a topic.

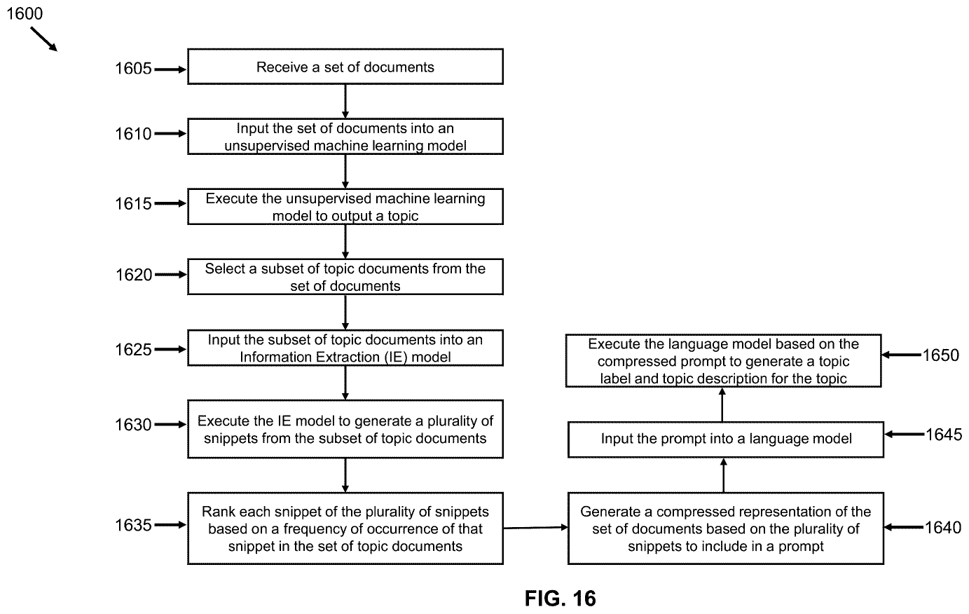

Referring now to FIG. 16, an example flowchart outlining operations of a process 1600 is shown, in accordance with some embodiments of the present disclosure. The process 1600 may be executed by one or more processors (e.g., the processor 1430) executing computer-readable instructions (e.g., the topic label and description generation instructions 1445) associated with the topic label and description generation application 1435. The process 1600 may be used for generating a topic label and topic description for a topic. The process 1600 may include other or additional operations in other embodiments. The process 1600 corresponds to Method 2 mentioned above.

At operation 1605, the processor receives a set of documents from which to generate a topic label and a topic description for a topic. The operation 1605 is analogous to the operation 1505. At operation 1610, the processor inputs the set of documents into an unsupervised machine learning model. The operation 1610 is analogous to the operation 1510. At operation 1615, the processor executes the unsupervised machine learning model to output the topic for the set of the documents, the topic having a plurality of topic terms. The operation 1615 is analogous to the operation 1515. Although a single topic is described herein, the unsupervised machine learning model may generate a plurality of topics, and the process 1600 may be applied to each topic in the plurality of topics.

At operation 1620, the processor selects a subset of topic documents from the set of documents. The subset of topic documents belong to the topic. In some embodiments, the subset of topic documents may be selected based on the plurality of topic terms. In some embodiments, not each document may include text that corresponds to a generated topic. By selecting a subset of documents from the set of documents as the subset of topic documents, the proposed approach identifies the documents that are relevant to the topic. Thus, in some embodiments, the processor may identify all those documents from the set of documents that have text corresponding to the topic (e.g., belong to the topic). These identified documents may form the subset of topic documents for a topic. Thus, for each topic, the processor may identify a subset of documents, referred to herein as a subset of topic document, that belong to that topic.

In some embodiments, the further filtering, sorting, and/or ranking of the subset of topic documents may be performed. For example, in some embodiments, the processor may further identify those documents from the subset of topic documents that are most relevant to the topic (e.g., top N documents) based on the plurality of topic terms. For example, in some embodiments, the processor may identify those documents from the subset of topic documents that have the greatest number of topic terms from the plurality of topic terms. In some embodiments, the processor may identify those documents from the subset of topic documents that have certain topic terms that are most frequently occurring. In other embodiments, the processor may use other techniques to identify the subset of topic documents. Further, in some embodiments, the number of documents in the subset of topic documents may be predetermined. In such instances, the processor may be configured to identify the predetermined number of documents from the set of documents as the subset of topic documents.

At operation 1625, the processor inputs the subset of topic documents (e.g., all of the documents in the subset of topic documents or the top N documents) into an information extraction (IE) model. An IE model is configured to automatically extract structured information from unstructured text. Thus, in some embodiments, the IE model may be configured to extract information from the subset of topic documents. In some embodiments, the subset of topic documents may be input into the IE model. The IE model may be trained to extract certain information from the subset of topic documents. For example, in some embodiments, the IE model may be trained to extract a snippet highlighting key information about the document. In some embodiments, the IE model may be trained to extract other or additional information such as identifying any key entities (e.g., people, organizations, dates, etc.), relationships between entities, any events associated with the topic, etc. from the subset of topic documents. Thus, in some embodiments, the IE model may be trained to extract one or more snippets from the subset of topic documents.

In some embodiments, the IE model may be a rule-based model. A rule-based IE model may rely on predefined patterns and rules to extract the relevant information (e.g., snippets). Unlike machine learning models, which learn from data, rule-based models use predefined rules to identify and extract information from the subset of topic documents. For example, in some embodiments, a rule-based IE model may use pattern matching rules to identify specific sequences of text that match predetermined patterns predefined in the pattern matching rules. In some embodiments, a rule-based IE model may use linguistic rules that apply grammatical and syntactic rules to understand structure of text and identify text based on those rules. In some embodiments, a rule-based IE model may use domain-specific rules that include rules relevant to a specific domain or application (e.g., medical, legal, finance, etc.). In some embodiments, a rule-based IE model may use a combination of one or more of the pattern matching rules, linguistic rules, and domain-specific rules. In other embodiments, a rule-based IE model may use other, different, or additional types of rules. Examples of rule-based models that may be used herein may include General Architecture for Text Engineering (GATE) model, Stanford TokensRegex model, Apache Unstructured Information Management Architecture (UIMA) model, SpaCy's Matcher model, SAS Visual Text Analytics concepts model, etc.

In some embodiments, the IE model may be a machine learning (ML) model. An ML model may be configured to automatically learn patterns and features from the data itself to extract structured information from unstructured text. Unlike rule-based models, which rely on predefined rules to extract relevant information, ML models learn autonomously from the data (e.g., the subset of topic documents) to extract the relevant information. In some embodiments, examples of ML models that may be used herein may include supervised learning models such as Named Entity Recognition (NER) model for identifying and classifying entities in text, Relation Extraction models like Support Vector Machines for identifying relationships between entities, Event Extraction models such as Recurrent Neural Networks (RNNs) and Transformers to identify events and associated participants, etc. In some embodiments, examples of ML models that may be used herein may also include semi-supervised learning models that may use a combination of labeled and unlabeled data to improve extraction performance, deep learning models like Bidirectional Encoder Representations from Transformers (BERT), Generative Pre-Trained Transformers (GPT), or other transformers to identify complex textual patterns, Sequence-to-Sequence models such as RNNs or transformer models for tasks like summarization and translation, etc. In some embodiments, examples of ML models that may be used herein may also include extractive summarization models that may be configured to generate summaries of text. In other embodiments, examples of ML models that may be used herein may include other, additional, or different models.

In some embodiments, a combination of one or more rule-based models may be used for the IE model. In some embodiments, a combination of one or more ML models may be used for the IE model. In some embodiments, a combination of one or more rule-based models and one or more ML models may be used. Thus, at the operation 1625, the processor inputs the subset of topic documents into an IE model to extract relevant information (e.g., snippets) from the subset of topic documents. Additional details of rule-based models and ML models may be found in Tang, J., Hong, M., Zhang, D. L. and Li, J., “Information Extraction: Methodologies and Applications”, Emerging Technologies of Text Mining: Techniques and Applications (pp. 1-33) (2008), IGI Global, https://doi.org/10.4018/978-1-59904-373-9.ch001; Small S G, Medsker L, “Review of information extraction technologies and applications” (2013) Neural Computing and Applications, 25:33-548; Mooney R J, Bunescu R, “Mining Knowledge from Text Using Information Extraction,” ACM SIGKDD Explorations Newsletter, Volume 7, Issue 1 (pp 3-10) (2005), https://doi.org/10.1145/1089815.10898; Jade, Teresa, Biljana Belamaric Wilsey, and Michael Wallis, “SAS® Text Analytics for Business Applications: Concept Rules for Information Extraction Models” (2019) Cary, NC: SAS Institute Inc., the entireties of which are incorporated by reference herein.

At operation 1630, the processor executes the IE model to generate a plurality of snippets from the subset of topic documents for the topic. Each snippet of the plurality of snippets may include a chunk of text extracted by the IE model from the subset of topic documents. In some embodiments, each snippet of the plurality of snippets may include a plurality of key words from the subset of topic documents. In some embodiments, each snippet of the plurality of snippets may include a plurality of key phrases from the subset of topic documents. In some embodiments, each snippet of the plurality of snippets may include a combination of key words and key phrases from the subset of topic documents. Further, in some embodiments, each snippet of the plurality of snippets may further include context around at least one of one or more of the key words or one or more of the key phrases. In some embodiments, context may involve determining a predetermined number of tokens on either side of a key word or phrase, defining one or more rules that identify potential useful neighboring concepts (e.g., allowing for inclusion of a neighboring verb and intervening text that is within x tokens from the key word or phrase), or looking for boundaries defined by the structure of the language (e.g., sentences, clauses, phrases, etc.). In other embodiments, the processor may identify context in other ways.

In some embodiments, the IE model may be trained to generate a number of snippets from each document of the subset of topic documents related to the topic. In some embodiments, a snippet may be associated with multiple documents. For example, in some embodiments, if the topic relates to computer technology and multiple documents discuss differences between on-premise computing and virtual computing, a snippet relating to differences between on-premise and virtual computing may be relevant to multiple documents. In some embodiments, the IE model may be configured to identify synonyms and associate snippets when synonyms are used. For example, if document 1 uses terminology related to virtual computing but document 2 uses terminology related to cloud computing, the IE model may determine that virtual computing and cloud computing are generally synonymous. Thus, the processor may indicate that a snippet related to differences between cloud computing and on-premise computing is also associated with document 1, while a snippet related to differences between virtual computing and on-premise computing is also associated with document 2. Thus, the processor may identify one or more snippets from each document in the subset of topic documents related to the topic. Therefore, the snippets are a more accurate representation of the topic than the subset of topic documents.

At operation 1635, the processor ranks the plurality of snippets based on a frequency of occurrence of each snippet of the plurality of snippets in the set of topic documents. In some embodiments, the higher the frequency of occurrence, the higher the rank of the snippet. The processor may also select a predetermined number of highest ranked snippets of the plurality of snippets to obtain a subset of snippets. In particular, to further reduce the number of tokens being input into an LLM, the proposed approach identifies the most relevant snippets from the plurality of snippets generated at the operation 1630. In some embodiments, the processor may be configured to identify those snippets that most frequently occur across documents. Snippets that occur most frequently across the subset of topic documents may be indicative of the importance of those snippets. In other embodiments, the processor may rank the plurality of snippets using another metric. Thus, at the operation 1635, the processor selects a subset of snippets from the plurality of snippets generated at the operation 1630.

At operation 1640, the processor generates a compressed representation of the set of documents based on the plurality of snippets to include in a prompt. In particular, the processor concatenates the subset of snippets from the operation 1635 to generate a string for the topic. An example concatenated string may look like:
Topic 1: [(‘rearview mirror assembly’, 225), (‘vision system’, 72), (‘reflective element’, 68), (‘electric aircraft’, 51), (‘drive unit’, 40), (‘charging system’, 37), (‘interior mirror’, 34), (‘glass substrate’, 34), (‘electric vehicle’, 33), (‘front surface’, 31), (‘improved wheel cover overlay’, 30), (‘electric vehicle’, 28), (‘power modules’, 27), (‘plastic housing’, 25), (‘said mirror’, 24), (‘vehicular electric’, 24), (‘disruption element’, 21), (‘vehicle drive unit’, 20), (‘radiant panel’, 20), (‘mirror system’, 20)]

In the example above, the text within each parenthesis may be a separate snippet and the number next to the text may indicate that snippet's rank (e.g., how many times the snippet occurred across the subset of topic documents). For example, in the snippet “‘rearview mirror assembly’, 225,” the snippet is the text “rearview mirror assembly” and the number 225 indicates the rank of that snippet. Thus, this snippet appeared 225 times across the subset of topic documents. The processor also generates a prompt for the LLM based on the string. The operation 1640 is analogous to the operation 1540 but using snippets instead of topic terms. An example of the prompt may be:

```
messages=[
  {“role”: “system”, “content”: “You are a data scientist.”},
  {“role”: “user”, “content”: “Generate concise topic names and
corresponding descriptions based on the top 20 topic words and
frequencies in the patent data category VEHICLES provided in
below TEXT.
```

The summary of the topic should include some illustrative concepts related to the topic and how they relate to the topic or domain.
The output in this format: topic 1: topic name: Summarize what this topic is about and its underlying clues.
///TEXT: Topic 1: [(‘rearview mirror assembly’, 225), (‘vision system’, 72), (‘reflective element’, 68), (‘electric aircraft’, 51), (‘drive unit’, 40), (‘charging system’, 37), (‘interior mirror’, 34), (‘glass substrate’, 34), (‘electric vehicle’, 33), (‘front surface’, 31), (‘improved wheel cover overlay’, 30), (‘electric vehicle’, 28), (‘power modules’, 27), (‘plastic housing’, 25), (‘said mirror’, 24), (‘vehicular electric’, 24), (‘disruption element’, 21), (‘vehicle drive unit’, 20), (‘radiant panel’, 20), (‘mirror system’, 20)]}.

At operation 1645, the processor inputs the prompt of the topic into a language model similar to the operation 1545. At operation 1650, the processor executes the language model based on the prompt to generate the topic label and the topic description for the topic similar to the operation 1550. An example output that may be generated from the LLM may look like:
Topic 1: Rearview Mirror Assembly and Mounting System: This topic focuses on the assembly and mounting of rearview mirrors in vehicles. It includes concepts such as reflective elements, front surfaces, interior mirrors, and base portions. The topic also mentions related components like driver airbag apparatus, electric vehicles, and mirror systems.

In the example above, the topic name is “Rearview Mirror Assembly and Mounting Systems” and is followed by a description of the topic. This method generates a readable and useful label and description for all topics. The topic label and topic description generated by Method 2 is somewhat more detailed and targeted than the topic label and topic description generated by Method 1.

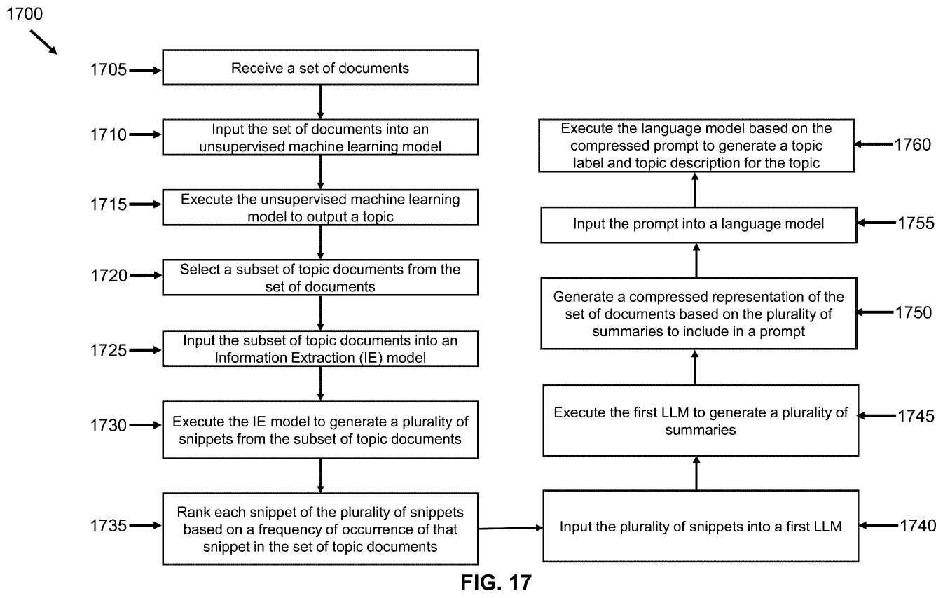

Referring now to FIG. 17, an example flowchart outlining operations of a process 1700 is shown, in accordance with some embodiments of the present disclosure. The process 1700 may be executed by one or more processors (e.g., the processor 1430) executing computer-readable instructions (e.g., the topic label and description generation instructions 1445) associated with the topic label and description generation application 1435. The process 1700 may be used for generating a topic label and topic description for a topic. The process 1700 may include other or additional operations in other embodiments. The process 1700 corresponds to Method 3 mentioned above.

At operation 1705, the processor receives a set of documents from which to generate a topic label and a topic description for a topic. The operation 1705 is analogous to the operation 1505. At operation 1710, the processor inputs the set of documents into an unsupervised machine learning model. The operation 1710 is analogous to the operation 1510. At operation 1715, the processor executes the unsupervised machine learning model to output the topic for the set of the documents, the topic having a plurality of topic terms. The operation 1715 is analogous to the operation 1515. Although a single topic is described herein, the unsupervised machine learning model may generate a plurality of topics, and the process 1700 may be applied to each topic in the plurality of topics.

At operation 1720, the processor selects a subset of topic documents from the set of documents. The operation 1720 is similar to the operation 1620. Thus, in some embodiments, the processor may identify subset of topic documents that belong to each topic. In some embodiments, the processor may further identify the top N documents from the subset of topic documents. In some embodiments, the processor may identify the top N documents through relevancy scores provided by the unsupervised machine learning model (e.g., the topic model). For example, both LDA and SVD models offer scores that indicate the relevancy of documents to topics. In particular, LDA provides the relevancy scores through topic distributions, while SVD provides relevancy scores by projecting documents into a reduced space and measuring their similarity. Thus, in some embodiments, the processor identifies the top N documents as the documents having the highest relevancy scores. In other embodiments, the processor may use other mechanisms to identify the top N documents.

At operation 1725, similar to the operation 1625, the processor inputs the top N documents into an IE model and executes the IE model at operation 1730, similar to the operation 1630, to generate a plurality of snippets from the subset of topic documents (e.g., the predetermined number of top documents). A plurality of snippets may be generated from each of the top N documents. At operation 1735, the processor optionally ranks the plurality of snippets based on a frequency of occurrence of each snippet of the plurality of snippets, similar to the operation 1635, and selects a subset of snippets. At operation 1740, the processor inputs the subset of snippets (e.g., ranked or unranked) into an LLM (e.g., a first LLM) to generate a plurality of summaries from the subset of snippets and at operation 1745, the processor executes the first LLM to generate the plurality of summaries.

In some embodiments, the processor may input all the plurality of snippets into the first LLM. Additional details about the implementation of an LLM may be found in Brown, Mann, et al. “Language Models are Few-Shot Learners” (2020), the entirety of which is incorporated by reference herein. In some embodiments, the processor may generate at least one summary for each of the subset of topic documents from the plurality of snippets to obtain the plurality of summaries. As discussed above, each of the top N documents may generate a plurality of snippets. The first LLM may generate a summary from the plurality of snippets of a particular document. Thus, each document of the top N documents may have a summary generated from the plurality of snippets of that document.

A “summary” of a topic document may be a condensed version of that topic document. In particular, the first LLM may use its understanding of language patterns and context to extract the main themes, main points, and/or essential details from the plurality of snippets associated with a particular topic document to generate the summary for that topic document. In some embodiments, the first LLM may combine the information from the plurality of snippets associated with each topic document to generate a summary for that topic document.

A summary may be different than a snippet. For example, in some embodiments, a summary may be longer than a snippet (which may be just a few sentences or a paragraph). A summary may provide a more comprehensive overview of the main points or themes or key details of the entire topic document, while a snippet may provide a brief excerpt of or highlight from the topic document. A summary may provide an understanding of the entire text of a topic document without having to read the entire text, while a snippet may provide a headline or teaser of the context. For example, a summary of an article may include the primary focus of the article, important arguments, findings, conclusion of the article, and any essential facts, data, or examples to support the arguments and findings, etc. A snippet of the same article may include the headline of the article and/or a sentence or two (or perhaps a paragraph) from the article to give a quick idea of what the article is about. Thus, the length, content, and purpose of a summary may be different from the length, content, and purpose of a snippet.

At operation 1750, the processor generates a compressed representation of the set of documents based on the plurality of summaries to include in a prompt. In some embodiments, the processor may generate one prompt for each summary of the plurality of summaries. In other embodiments, the processor may concatenate all of the summaries generated from the first LLM to generate a string and use the string in the prompt. The prompt may be similar to the prompt described at the operation 1540 but using a summary instead of topic terms. For example, the processor may generate a prompt as follows:

```
messages=[
  {“role”: “system”, “content”: “You are a data scientist.”},
  {“role”: “user”, “content”: “Generate concise topic names and
corresponding descriptions based on summaries of the top 5 documents
in the topic from the patent data category VEHICLES provided in below
TEXT.
```

The summary of the topic should include some illustrative concepts related to the topic and how they relate to the topic or domain.
The output in this format: topic 1: topic name: Summarize what this topic is about.

### ///TEXT:}

The “TEXT” in the prompt above may include, for example the summary or summaries generated from the first LLM as follows:
Topic 1: The text describes a rearview mirror assembly with a powerfold actuator that allows the mirror head to pivot between folded and drive positions. The text describes a rearview mirror assembly for vehicles, including a mirror mount, mirror casing, and mirror reflective element. The method involves manufacturing a variable reflectance mirror for a rearview mirror assembly using multiple glass substrates and electrochromic medium. The text describes a rearview mirror assembly with an adjustable mirror head and an interior mirror reflective element. It also includes details about the camera, illumination sources, and film coatings used in the assembly. The text describes a fastener clip with pairs of legs, arms, and projections that engage openings and secure it to a blade or chassis.

At operation 1755, the processor inputs each of the prompts of the topic into a language model similar to the operation 1545. At operation 1760, the processor executes the language models based on the prompts to generate the topic label and the topic description for the topic similar to the operation 1550. An example output that may be generated from the language model may look like:
Topic 1: Rearview Mirror Assembly: This topic discusses the design and manufacturing of rearview mirror assemblies for vehicles. It includes details about powerfold actuators, adjustable mirror heads, and various components such as mirror mounts, casings, and reflective elements.

In the example above, the topic name is “Rearview Mirror Assembly” and is followed by a description of the topic. This method generates a readable and useful label and description for all topics. The topic label and topic description generated by Method 3 is more detailed and targeted than the topic label and topic description generated by Methods 1 and 2.

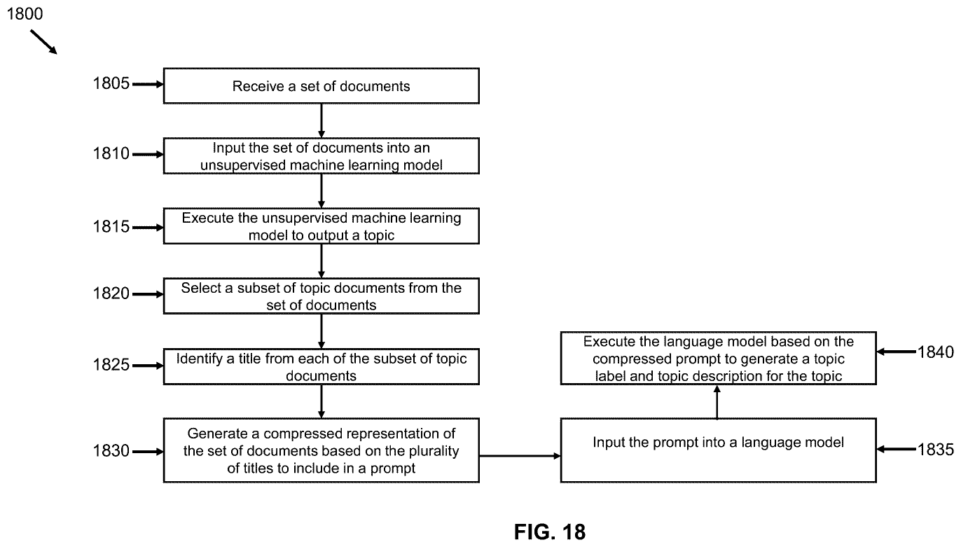

Referring now to FIG. 18, an example flowchart outlining operations of a process 1800 is shown, in accordance with some embodiments of the present disclosure. The process 1800 may be executed by one or more processors (e.g., the processor 1430) executing computer-readable instructions (e.g., the topic label and description generation instructions 1445) associated with the topic label and description generation application 1435. The process 1800 may be used for generating a topic label and topic description for a topic. The process 1800 may include other or additional operations in other embodiments. The process 1800 corresponds to Method 4 mentioned above.

At operation 1805, the processor receives a set of documents from which to generate a topic label and a topic description for a topic. The operation 1805 is analogous to the operation 1505. At operation 1810, the processor inputs the set of documents into an unsupervised machine learning model. The operation 1810 is analogous to the operation 1510. At operation 1815, the processor executes the unsupervised machine learning model to output the topic for the set of the documents, the topic having a plurality of topic terms. The operation 1815 is analogous to the operation 1515. Although a single topic is described herein, the unsupervised machine learning model may generate a plurality of topics, and the process 1800 may be applied to each topic in the plurality of topics.

At operation 1820, the processor selects a subset of topic documents from the set of documents. The operation 1820 is similar to the operation 1720. At operation 1825, the processor identifies a title from each of the subset of topic documents. In some embodiments, the processor may generate the title from each of the subset of topic documents from metadata of each of the subset of topic documents. In some embodiments, each topic document in the subset of topic documents may be associated with metadata. The metadata may provide information about the topic document. For example, in some embodiments, the metadata may include a title, author, and main keywords of the topic document. In some embodiments, the metadata may indicate how the topic document is organized (e.g., how pages are ordered, number of pages, how chapters are structured, etc.). In some embodiments, the metadata may provide administrative information such as when the topic document was created, how the topic document was created, file type, access permissions, etc. In other embodiments, the metadata may include other, additional, or different information. Thus, in some embodiments, the processor may extract the title from the metadata.

In some embodiments, the processor may generate the title from the body of text of each of the subset of topic documents. The body of a topic document is the main section of the topic document that describes the primary content of the topic document. In some embodiments, to generate the title from the body of a topic document, the processor may extract the first sentence of first n paragraphs in the body of the topic document. In some embodiments, n may be predetermined (e.g., user defined). For example, in some embodiments, the processor may extract the first sentence of the first ten paragraphs in the body of the topic document. In some embodiments, the processor may concatenate the extracted first sentences to generate the title. In some embodiments, the processor may summarize the extracted first sentences to generate the title. In some embodiments, the processor may input the extracted first sentences into an LLM and execute the LLM to generate the title.

In some embodiments, the processor may extract the first sentence of a topic document and use the extracted first sentence as a title of that topic document. In some embodiments, the processor may extract a first paragraph from the body of the topic document and input the first paragraph into an LLM (or another suitable language model). The processor may execute the LLM to generate the title. In some embodiments, the processor may extract a line (e.g., a first sentence or another representative sentence) from the body of the topic document, input the first line into an LLM (or another suitable language model), and execute the LLM to generate the title. In some embodiments, the processor may input the subset of topic documents into an IE model to generate a plurality of snippets, execute the IE model to generate the plurality of snippets, input the plurality of snippets into an LLM (or another suitable language model), and execute the LLM to generate a title for each of the subset of topic documents to obtain a plurality of titles. In other embodiments, the processor may use other, additional, or different mechanisms to generate a title for each of the subset of topic documents.

At operation 1830, the processor generates a compressed representation of the set of documents based on the plurality of titles to include in a prompt. In some embodiments, the processor may generate one prompt for each title that is generated at the operation 1820. In other embodiments, the processor may concatenate all of the titles generated at the operation 1820 to generate a title string and use the title string in the prompt. The prompt may be similar to the prompt described at the operation 1540 but using a title instead of topic terms. For example, the processor may generate a prompt as follows:

```
messages=[
  {“role”: “system”, “content”: “You are a data scientist.”},
  {“role”: “user”, “content”: “Generate concise topic names and
corresponding descriptions based on titles of the top 10 documents in the
topic from the patent data category VEHICLES provided in below TEXT.
```

The summary of the topic should include some illustrative concepts related to the topic and how they relate to the topic or domain.
The output in this format: topic 1: topic name: Summarize what this topic is about.

### ///TEXT:}

The “TEXT” in the prompt above may include, for example the title or titles generated at the operation 1820 as follows: Topic 1: [‘powerfold actuator for exterior mirror’, ‘interior rearview mirror assembly with circuitry at mirror mount’, ‘process for manufacturing a plurality of ec mirror cells using glass sheet for multiple front substrates’, ‘interior rearview mirror assembly with driver monitoring system’, ‘arrowhead fastener clip with barbs’, ‘rubber composition, crosslinked body, and tire’, ‘wheel cover quick mount’, ‘overmolded metal-plastic clip’, ‘vehicle seat cover’, ‘charging vehicle for a stack storage assembly’]

At operation 1835, the processor inputs the prompt of the topic into a Large Language Model (LLM) similar to the operation 1545. At operation 1840, the processor executes the LLM based on the prompt to generate the topic label and the topic description for the topic similar to the operation 1550. An example output that may be generated from the LLM may look like:
Topic 1: Exterior Mirror Technology: This topic focuses on various advancements in powerfold actuators for exterior mirrors, including the manufacturing process and materials used. It also includes innovations in interior rearview mirror assemblies with circuitry and driver monitoring systems.

In the example above, the topic name is “Exterior Mirror Technology” and is followed by a description of the topic. This method generates a readable and useful label and description for all topics. The topic label and topic description generated by Method 4 may be less detailed than the topic label and topic description generated by Methods 1-3.

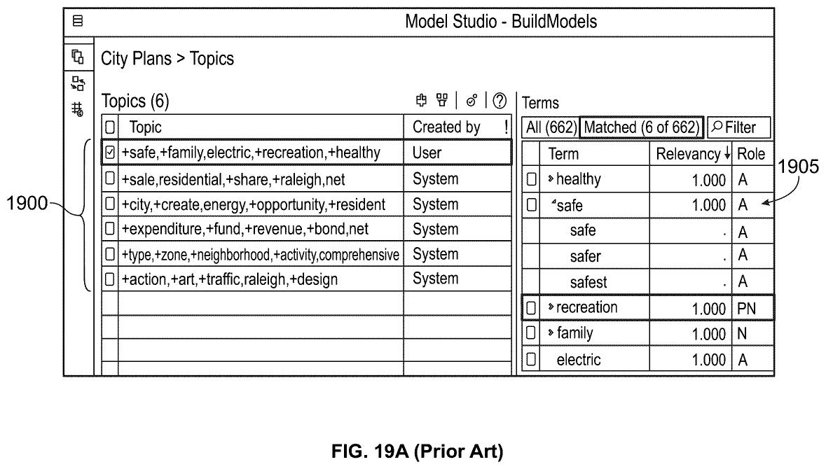

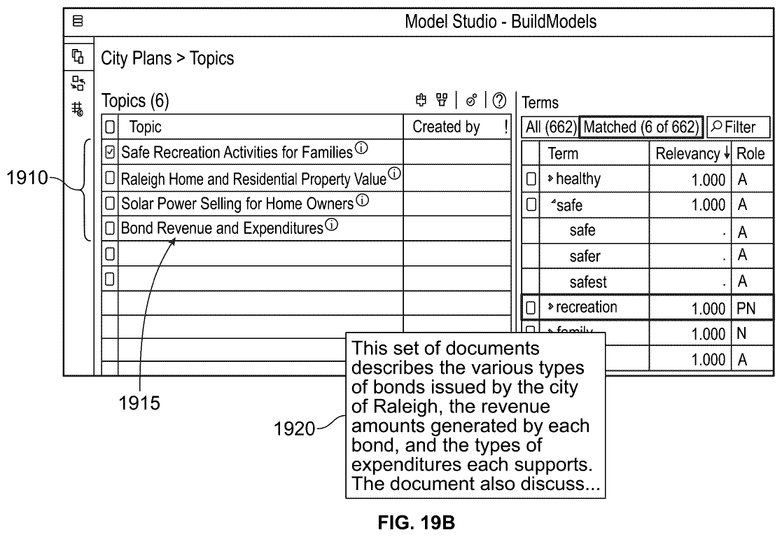

Turning to FIGS. 19A and 19B, example screenshots are shown, in accordance with some embodiments of the present disclosure. FIG. 19A shows an example screenshot of existing technology, while FIG. 19B shows a screenshot of the proposed approach. The screenshots of FIGS. 19A and 19B are generated using SAS Text Analytics, provided by SAS Institute Inc. of Cary, North Carolina. The screenshots of FIGS. 19A and 19B are generated using an SVD topic model.

In FIG. 19A, a list of topics 1900 are presented in list form. These topics are generated from a set of documents using existing technology. Each topic in the list is represented by a set of five topic terms. The “+” symbol before certain topic terms of each topic indicates that these terms are parents of multiple variant terms. The variants of these topic terms may be expanded, as shown on right side portion 1905 for topic term “safe.” The topic terms in the list of topics 1900 are not descriptive and do not provide any understanding what the topics are.

In contrast, FIG. 19B shows a screenshot in which a list of topics 1910 are generated using the proposed approach. The screenshot of FIG. 19B illustrates how any of the proposed approaches (Methods 1-4) may generate a topic label and topic description. The text in each topic in the list of topics 1910 is a topic label generated using any of the proposed approaches. Each topic label is in a more understandable format and provides an indication of what the topic is. By hovering over a topic, the topic description associated with that topic label may be viewed. For example, by hovering on topic 1915, its topic description 1920 may be seen. Thus, the list of topics 1910 in FIG. 19B provides more information about the set of documents than the list of topics 1900 of FIG. 19A.

### Patent Document Experiments

Inventors conducted experiments comparing the four methods (Methods 1-4) described above amongst themselves, as well as comparing the four methods with three existing methods. The experiments were performed using LDA topic modeling. When using LDA to generate the topics, the Natural Language ToolKit (NLTK) library was used as well as the base NLTK stop list. NLTK is a library in Python used for working with human language data (e.g., text) for National Language Processing (NLP) tasks. It provides a suite of text processing libraries for classification, tokenization, stemming, tagging, parsing, sematic reasoning, etc. The NLTK stop list is a collection of common words that may be filtered out during text processing. These words (also called stop words) may include words considered to have little value in terms of meaning and may be removed to focus on more significant words in the text. Examples of stop words may include “the,” “is,” “of,” “and,” etc.

The IE model, used for methods that require one, was built by leveraging the noun group model that is provided in the SAS Visual Text Analytics product provided by SAS Institute Inc. of Cary, North Carolina plus some context rules based primarily on important verbs in the text. The information extraction model used was not a domain-specific model. Further, OpenAI-3-small embeddings with cosine similarity was used as a metric to compare the various methods.

The data (e.g., the set of documents) included 1105 patents from the B60 VEHICLES category, which may be found at https://bulkdata.uspto.gov/data/patent/application/redbook/fulltext/2023/. The claim text from each patent was used instead of the full documents to expedite the results. Even using just the claim text, one document was too long to put into some prompts for LLMs because the tokens exceed the allowed context window. The abstract sections and patent titles were also used as benchmarks to compare the generated topic labels and topic descriptions.

In Method 1, the top 20 topic terms (after re-ranking the top 500 topic terms) were used in the prompt. In Method 2, the top 20 most frequent snippets were used in the prompt. In Method 3, five document summaries were used in the prompt. In Method 4, ten document titles were used in the prompt. These counts were selected to optimize the processing time and the strengths of each approach. Other counts may be used in each method. Because there is no gold standard topic label and topic description for these topics, three benchmarks were used to compare the generated topic label and topic description to a reference. The first benchmark provided a baseline. The baseline compared the input TEXT provided in the prompt with the generated topic name and topic description for similarity. The second benchmark compared the generated topic label and topic description with the abstracts of the patent documents in the topic. The 10 top relevant patent documents of each topic cluster were used in the evaluation. A topic name and topic description were compared to each of the abstracts of the patent documents. The maximum number of comparisons was 100. The third benchmark compared the generated label and description with titles of the patent documents in the topic using up to 100 patent documents for the comparison.

### Results of Comparisons for Similarity

Similarity refers to the degree of closeness or resemblance between two pieces of text, such as a generated response and a reference answer. Similarity metrics may be used to assess how well a model's output matches the expected or correct output, which may be a human-generated summary, a factual response, or any other predefined target text. In these experiments, similarities between the LLM response and the LLM input, the abstracts, and the titles (e.g., the benchmarks) were compared.

Table 1 below shows the results of experiments comparing Methods 1-4 of the proposed approach and the score using OpenAI embeddings plus cosine similarity. The highest similarity, looking at the mean value, was between LLM input and output across all methods. In particular, the task is to generate a topic label and description using an LLM, which means providing a summary based on a given set of words, phrases, or sentences. A high similarity with the input suggests that the summary closely follows the information provided. Since the abstracts or titles are not directly fed into the LLM but are derived from the documents within the respective topic clusters, some level of similarity is expected. However, this similarity will likely be much lower than the similarity between the LLM output and the text input itself. The more similar the output is to the three comparison benchmarks, the higher the relevance of the LLM's summary to the topic text.

TABLE 1

| Topic | | | | |
|---|---|---|---|---|
| Summary | | | | |
| compared | | | | |
| with | Method 1 | Method 2 | Method 3 | Method 4 |
| LLM | Mean: 0.783 | Mean: 0.822 | Mean: 0.84 | Mean: 0.819 |
| Input | Std | Std | Std | Std |
| (10 pairs) | Deviation: | Deviation: | Deviation: | Deviation: |
| | 0.009 | 0.006 | 0.029 | 0.016 |
| | Range: 0.037 | Range: 0.018 | Range: 0.082 | Range: 0.049 |
| | Median: | Median: | Median: | Median: |
| | 0.785 | 0.82 | 0.847 | 0.818 |
| Patent | Mean: 0.394 | Mean: 0.435 | Mean: 0.451 | Mean: 0.42 |
| abstract | Std | Std | Std | Std |
| (100 | Deviation: | Deviation: | Deviation: | Deviation: |
| pairs) | 0.114 | 0.132 | 0.13 | 0.115 |
| | Range: 0.517 | Range: 0.6 | Range: 0.568 | Range: 0.612 |
| | Median: | Median: | Median: | Median: |
| | 0.414 | 0.417 | 0.473 | 0.422 |
| Patent | Mean: 0.357 | Mean: 0.387 | Mean: 0.432 | Mean: 0.429 |
| title | Std | Std | Std | Std |
| (100 | Deviation: | Deviation: | Deviation: | Deviation: |
| pairs) | 0.118 | 0.115 | 0.126 | 0.138 |
| | Range: 0.629 | Range: 0.53 | Range: 0.56 | Range: 0.679 |
| | Median: | Median: | Median: | Median: |
| | 0.37 | 0.368 | 0.416 | 0.417 |

Row two from the top of Table 1 provides results for the first benchmark comparison, row three from the top provides results for the second benchmark comparison, and row four from the top provides results for the third benchmark comparison. The mean value for each benchmark provides a score for similarity. The higher the mean value, the higher the similarity. Thus, ranking Methods 1-4 from the highest mean value to the lowest value across all three benchmarks, it is seen that Method 3 has the highest mean value for all three benchmarks, followed by Method 2, and then Method 3. Method 4 varied in the rankings. The mean value of Method 4 was higher than Method 1 in the first two benchmarks, but lower than the mean values of methods 2 and 3. Further, for the first and second benchmarks, the mean values of Methods 2 and 4 are close to each other. However, for the third benchmark, Method 4 ranked as the second-best method, above Method 2, suggesting that good quality titles may be used in place of snippets, when they are available, and still produce good summaries.

Table 2 shows the results of experiments comparing three conventional mechanisms and the score using OpenAI embeddings plus cosine similarity. The first conventional mechanism uses top 20 topic terms as a prompt into an LLM to generate a topic summary. The second conventional mechanism uses top 20 topic terms plus a portion of top 4 documents as a prompt into an LLM to generate the topic summary. The third conventional mechanism uses top 500 topic terms as input into an LLM to generate the topic summary. The same measurements and data as Table 1 were used for the results in Table 2.

TABLE 2

| Topic | | Top 20 topic | |
|---|---|---|---|
| Summary | | terms + top | |
| compared | Top 20 topic | 4 documents | Top 500 topic |
| with | terms | (truncated) | terms |
| LLM | Mean: 0.729 | Mean: 0.672 | Mean: 0.461 |
| Input | Std | Std | Std |
| (10 | Deviation: | Deviation: | Deviation: |
| pairs) | 0.014 | 0.01 | 0.005 |
| | Range: 0.052 | Range: 0.028 | Range: 0.016 |
| | Median: 0.732 | Median: 0.669 | Median: 0.461 |
| Patent | Mean: 0.391 | Mean: 0.389 | Mean: 0.374 |
| abstract | Std | Std | Std |
| (100 | Deviation: | Deviation: | Deviation: |
| pairs) | 0.108 | 0.133 | 0.093 |
| | Range: 0.467 | Range: 0.656 | Range: 0.458 |
| | Median: 0.394 | Median: 0.372 | Median: 0.381 |
| Patent | Mean: 0.358 | Mean: 0.362 | Mean: 0.351 |
| title | Std | Std | Std |
| (100 | Deviation: | Deviation: | Deviation: |
| pairs) | 0.115 | 0.128 | 0.097 |
| | Range: 0.515 | Range: 0.628 | Range: 0.391 |
| | Median: 0.361 | Median: 0.366 | Median: 0.357 |

Comparing the mean values from Table 2 with the mean values from Table 1, it may be seen that for each of the three benchmarks, each of the three conventional mechanism has a lower mean value than even the lowest mean value for that benchmark in Table 1. Thus, all of the proposed Methods 1-4 perform better than the three conventional mechanisms of Table 2.

The experiments also compared the token counts (based on the BPE tokenizer used in the GPT model) of the input into the LLM model. Table 3 below provides the token counts for each of the proposed methods 1-4:

TABLE 3

| | Method 1 | Method 2 | Method 3 | Method 4 |
|---|---|---|---|---|
| LLM input token count | 444 | 991 | 1484 | 1148 |
| LLM output token count | 493.5 | 582.7 | 1165.6 | 574.4 |
| (mean) | | | | |

It may be seen from Table 3 above that Method 3 requires the greatest number of tokens using only 5 documents from the topic. The lowest token count, less than 50% of the next method goes to Method 1. The use of more input tokens correlates with the rankings provided in Table 1-more input tokens may result in better labels and descriptions for the topics. The token counts for the three conventional mechanisms are provided in Table 4 below:

TABLE 4

| | | Top 20 topic | |
|---|---|---|---|
| | | words and top | |
| | Top 20 | 4 documents | Top 500 |
| | topic words | (truncated) | topic words |
| LLM input token count | 432 | 34242 | 18241 |
| LLM output token count | 452.2 | 1127.8 | 956.7 |
| (mean) | | | |

Comparing the values in Tables 3 and 4 above, it may be seen that the token counts for the conventional mechanisms in Table 4, except the first one, are much higher than for any of Methods 1-4 in Table 3. The first conventional mechanism (top 20 topic words) performs closest to the lowest-performing proposed method in most of the comparisons but still performs worse on two out of three comparisons with about the same number of tokens.

### Results of Comparisons for Consistency

Another type of experiment conducted was to verify consistency of outputs with the difference input types. Consistency refers to the degree to which a model produces the same or similar outputs when presented with the same or similar inputs in different runs. Evaluating consistency is important for assessing the stability and reliability of a model's performance over time. Through these experiments, the consistency of the results generated by different prompts under the same model is assessed. When the temperature parameter is the same, a higher consistency value indicates that the response triggered by the prompt is more stable. In the context of LLMs, “temperature” is a parameter used during text generation that controls the randomness or creativity of the model's responses. The temperature parameter helps determine the probability distribution of the next word or token in a sequence.

In this experiment all four methods were compared, as well as the methods were compared to the three conventional mechanisms mentioned above. To measure consistency, ten topic labels and descriptions were generated with the same prompt. The average OpenAI with cosine similarity score was computed between the reference and the predictions.

The results of this experiment indicate that Method 2 generates more consistent outputs than the other methods. This indicates that the stochastic model is more confident about its results when the prompt contains snippets. Method 3 is the second most consistent method when the temperature is low but is edged out by the re-ranked terms method when it is higher. The least consistent method was Method 4. However, both Methods 3 and 4 seemed less impacted by the temperature setting. Additionally, when the temperature setting is lower, outputs are more consistent for all methods to some degree. Table 5 compares the results for Methods 1-4:

TABLE 5

| Temper- | | | | |
|---|---|---|---|---|
| ature | Method 1 | Method 2 | Method 3 | Method 4 |
| 0.1 | Mean: 0.984 | Mean: 0.997 | Mean: 0.977 | Mean: 0.943 |
| | Std | Std | Std | Std |
| | Deviation: | Deviation: | Deviation: | Deviation: |
| | 0.01 | 0.002 | 0.014 | 0.041 |
| | Range: 0.039 | Range: 0.008 | Range: 0.056 | Range: 0.118 |
| | Median: | Median: | Median: | Median: |
| | 0.987 | 0.997 | 0.98 | 0.945 |
| 0.3 | Mean: 0.974 | Mean: 0.979 | Mean: 0.972 | Mean: 0.937 |
| | Std | Std | Std | Std |
| | Deviation: | Deviation: | Deviation: | Deviation: |
| | 0.008 | 0.008 | 0.013 | 0.037 |
| | Range: 0.035 | Range: 0.031 | Range: 0.056 | Range: 0.131 |
| | Median: | Median: | Median: | Median: |
| | 0.974 | 0.979 | 0.975 | 0.94 |

From Table 5 above, comparing the mean values of Methods 1-4, it may be seen that Method 2 has the highest mean value for both temperature levels, followed by Method 1, then Method 3, and then Method 4. This means that of the 4 proposed methods, Method 1 produces the most consistent results, while Method 4 produces the least consistent results. Comparing the proposed methods to the three conventional mechanisms, Table 6 provides the results. It may be seen from Table 6 that the range of the mean values is 0.983-0.987 when the temperature setting is 0.1, while the proposed approaches have a higher mean value range of 0.943-0.997, suggesting that the proposed approaches produce more consistent results than the conventional mechanisms. When the temperature setting is 0.3, the three conventional mechanisms have a mean value range of 0.952-0.979, while the proposed approaches (except Method 4) have a higher mean value range of 0.937-0.979.

TABLE 6

| | | 20 topic | |
|---|---|---|---|
| | | words + 4 | |
| | 20 topic | docs | |
| Temperature | words | (truncated) | 500 topic words |
| 0.1 | Mean: 0.983 | Mean: 0.987 | Mean: 0.984 |
| | Std Deviation: | Std Deviation: | Std Deviation: |
| | 0.018 | 0.004 | 0.005 |
| | Range: 0.065 | Range: 0.017 | Range: 0.018 |
| | Median: 0.993 | Median: 0.988 | Median: 0.986 |
| 0.3 | Mean: 0.952 | Mean: 0.972 | Mean: 0.979 |
| | Std Deviation: | Std Deviation: | Std Deviation: |
| | 0.014 | 0.017 | 0.007 |
| | Range: 0.067 | Range: 0.058 | Range: 0.024 |
| | Median: 0.952 | Median: 0.98 | Median: 0.98 |

Amazon.com® Review Document Experiments

The experiments detailed in the previous section were repeated with a different set of documents. In these experiments, documents containing reviews written about products sold on the Amazon.com® website were used for the set of documents from which topic label and topic description were generated. Different benchmarks were used in these experiments as well. The first benchmark provided a baseline and compared the input TEXT provided in the prompt with the generated name and description for similarity. The second benchmark compared the generated label and description with the text of the documents in the topic. The 10 top relevant documents of each topic cluster were used in the evaluation. A topic name and description were compared to each of the documents. The maximum number of comparisons was 100. The third benchmark compared the generated label and description with titles of documents in the topic. The methodology was similar to comparison of the document text. In this case, up to 100 documents were selected for the comparison. Other than different data and different benchmarks, the same inputs that were used in the patent document experiments were used in these experiments.

The data (e.g., the set of documents) was sourced from https://huggingface.co/datasets/McAuley-Lab/Amazon-Reviews-2023 and consisted of 4,250 product reviews for five products, including “Beauty”, “Gift_cards”, “Industrial_and_scientific”, “Musical_instruments”, and “Toys_and_games”.

### Results of Comparisons for Similarity

Table 7 below shows the results of experiments comparing methods 1-4 of the proposed approach and the score using OpenAI embeddings plus cosine similarity. The highest similarity, looking at the mean value, was between LLM input and output across all methods.

TABLE 7

| Topic | | | | |
|---|---|---|---|---|
| summary | | | | |
| compared | | | | |
| with | Method 1 | Method 2 | Method 3 | Method 4 |
| LLM | Mean: 0.725 | Mean: 0.727 | Mean: 0.8 | Mean: 0.734 |
| Input | Std | Std | Std | Std |
| (10 | Deviation: | Deviation: | Deviation: | Deviation: |
| pairs) | 0.02 | 0.01 | 0.035 | 0.021 |
| | Range: 0.07 | Range: 0.035 | Range: 0.099 | Range: 0.069 |
| | Median: | Median: | Median: | Median: |
| | 0.727 | 0.729 | 0.792 | 0.744 |
| review | Mean: 0.227 | Mean: 0.288 | Mean: 0.262 | Mean: 0.253 |
| text | Std | Std | Std | Std |
| (100 | Deviation: | Deviation: | Deviation: | Deviation: |
| pairs) | 0.135 | 0.127 | 0.13 | 0.113 |
| | Range: 0.477 | Range: 0.504 | Range: 0.56 | Range: 0.485 |
| | Median: | Median: | Median: | Median: |
| | 0.204 | 0.275 | 0.25 | 0.24 |
| review | Mean: 0.161 | Mean: 0.19 | Mean: 0.176 | Mean: 0.261 |
| title | Std | Std | Std | Std |
| (100 | Deviation: | Deviation: | Deviation: | Deviation: |
| pairs) | 0.093 | 0.092 | 0.1 | 0.134 |
| | Range: 0.53 | Range: 0.465 | Range: 0.481 | Range: 0.538 |
| | Median: | Median: | Median: | Median: |
| | 0.137 | 0.175 | 0.152 | 0.221 |

Row two from the top of Table 7 provides results for the first benchmark comparison, row three from the top provides results for the second benchmark comparison, and row four from the top provides results for the third benchmark comparison. The mean value for each benchmark provides a score for similarity. The higher the mean value, the higher the similarity. Thus, ranking Methods 1-4 from the highest mean value to the lowest value across all three benchmarks, it is seen that in two of the three benchmarks, Method 3 has the highest mean value for all three benchmarks, followed by Method 2, and then Method 1. In the second benchmark, Method 3 had a higher mean value than Method 2.

Table 8 shows the results of experiments comparing three conventional mechanisms and the score using OpenAI embeddings plus cosine similarity. The first conventional mechanism uses top 20 topic terms as a prompt into an LLM to generate a topic summary. The second conventional mechanism uses top 20 topic terms plus a portion of top 4 documents as a prompt into an LLM to generate the topic summary. The third conventional mechanism uses the top 500 topic terms as input into an LLM to generate the topic summary. The same measurements and data as Table 7 were used for the results in Table 8:

### Results Table Showing Baseline Methods on Amazon.Com® Review Data:

TABLE 8

| Topic | | | |
|---|---|---|---|
| summary | | 20 topic words + | |
| compared with | 20 topic words | 4 docs | 500 topic words |
| LLM Input | Mean: 0.699 | Mean: 0.537 | Mean: 0.365 |
| (10 pairs) | Std Deviation: | Std Deviation: | Std Deviation: |
| | 0.024 | 0.012 | 0.007 |
| | Range: 0.065 | Range: 0.041 | Range: 0.024 |
| | Median: 0.691 | Median: 0.535 | Median: 0.363 |
| review text | Mean: 0.21 | Mean: 0.214 | Mean: 0.218 |
| (100 pairs) | Std Deviation: | Std Deviation: | Std Deviation: |
| | 0.122 | 0.112 | 0.109 |
| | Range: 0.511 | Range: 0.472 | Range: 0.447 |
| | Median: 0.199 | Median: 0.191 | Median: 0.225 |
| review title | Mean: 0.141 | Mean: 0.161 | Mean: 0.153 |
| (100 pairs) | Std Deviation: | Std Deviation: | Std Deviation: |
| | 0.08 | 0.074 | 0.076 |
| | Range: 0.439 | Range: 0.394 | Range: 0.402 |
| | Median: 0.126 | Median: 0.143 | Median: 0.133 |

Comparing the mean values from Table 8 with the mean values from Table 7, it may be seen that for each of the three benchmarks, each of the three conventional mechanisms has a lower mean value than even the lowest mean value for that benchmark in Table 7. Thus, all of the proposed Methods 1-4 perform better than the three conventional mechanisms of Table 8.

The experiments also compared the token counts (based on the BPE tokenizer used in the GPT model) of the input into the LLM model. Table 9 below provides the token counts for each of the proposed methods 1-4.

TABLE 9

| | Method 1 | Method 2 | Method 3 | Method 4 |
|---|---|---|---|---|
| LLM input | 469 | 1172 | 989 | 820 |
| token count | | | | |
| LLM output | 697.2 | 535.9 | 544.5 | 516.4 |
| token count | | | | |
| (mean) | | | | |

It may be seen from Table 9 above that Method 2 requires the greatest number of tokens. The lowest token count, less than 50% of the next method goes to Method 1. The use of more input tokens correlates with the rankings provided in Table 7-more input tokens may result in better labels and descriptions for the topics. The token counts for the three conventional mechanisms are provided in Table 10 below:

TABLE 10

| | | 20 topic | |
|---|---|---|---|
| | 20 topic words | words + 4 docs | 500 topic words |
| LLM input | 445 | 6361 | 18473 |
| token count | | | |
| LLM output | 557.4 | 983.4 | 1059.4 |
| token count | | | |
| (mean) | | | |

From Table 10 above, it may be seen that there is less consistency across the three benchmarks. For the first benchmark, the rankings (from the highest mean value to the lowest mean value) are as follows:
20 topic words
20 topic words+4 docs
500 topic words

For the second benchmark, the rankings are:
500 topic words
20 topic words+4 docs
20 topic words

For the third benchmark, the rankings are:
20 topic words+4 docs
500 topic words
20 topic words

In general, the texts themselves in the Amazon.com® experiments were relatively short, so the conventional mechanisms that use more input tokens may be more beneficial on shorter documents than for longer documents. Amazon.com® reviews might just be single sentences:
883.0: TEXT: Christmas gift that was loved.|TITLE: Allgirls love makkeup.
1111.0: TEXT: My 3 year old loved it|TITLE: Daughter loved it
1709.0: TEXT: My 11 year old loved it!|TITLE: Good for my 11 year old
1669.0: TEXT: My 6 yr old loves this!|TITLE: Five Stars
1236.0: TEXT: My 2 year old grandson loves it!|TITLE: Sturdy especially for 4 and under.

1890.0: TEXT: my 7 yr old granddaughter loves it|TITLE: good deal

3415.0: TEXT: Great product|TITLE: Great product

3547.0: TEXT: great product|TITLE: great product

In such cases, adding four documents to the topic words in the conventional mechanism won't make the input too long and may help improve the generated topic descriptions. However, when the original text is long (like a patent), the input may become excessively lengthy, which is a big drawback of the conventional mechanisms. For lengthy documents, the proposed approaches significantly perform better than the conventional mechanisms. Baseline method 3, which consistently uses 500 topic words, results in long inputs that are not very focused, making it an even less effective method in most comparisons.

Table 10 results do not correlate reliably with effectiveness of the method. Compared to the proposed approaches, the conventional mechanisms did worse for the first two comparisons compared to all of the proposed approaches.

### Results of Comparisons for Consistency

Another type of experiment conducted was to verify consistency of outputs with the difference input types. In this experiment all four methods were compared, as well as the methods were compared to the three conventional mechanisms mentioned above. To measure consistency, ten topic labels and descriptions were generated with the same prompt. The average OpenAI with cosine similarity score was computed between the reference and the predictions.

The results of this experiment indicate that Method 3 having the highest mean value when the temperature is low (e.g., 0.1) generates more consistent outputs than the other methods followed by Methods 1, 2, and 4 in that order. Table 11 compares the results for Methods 1-4:

TABLE 11

| Temper- | | | | |
|---|---|---|---|---|
| ature | Method 1 | Method 2 | Method 3 | Method 4 |
| 0.1 | Mean: 0.974 | Mean: 0.961 | Mean: 0.979 | Mean: 0.926 |
| | Std | Std | Std | Std |
| | Deviation: | Deviation: | Deviation: | Deviation: |
| | 0.01 | 0.013 | 0.011 | 0.051 |
| | Range: 0.04 | Range: 0.056 | Range: 0.037 | Range: 0.173 |
| | Median: | Median: | Median: | Median: |
| | 0.973 | 0.959 | 0.977 | 0.933 |
| 0.3 | Mean: 0.89 | Mean: 0.948 | Mean: 0.968 | Mean: 0.913 |
| | Std | Std | Std | Std |
| | Deviation: | Deviation: | Deviation: | Deviation: |
| | 0.036 | 0.011 | 0.008 | 0.054 |
| | Range: 0.143 | Range: 0.05 | Range: 0.034 | Range: 0.149 |
| | Median: | Median: | Median: | Median: |
| | 0.888 | 0.948 | 0.967 | 0.934 |

From Table 11 above, comparing the mean values of Methods 1-4, it may be seen that Method 3 has the highest mean value for both temperature levels, followed by Method 1, then Method 2, and then Method 4. This means that of the 4 proposed methods, Method 3 produces the most consistent results, while Method 4 produces the least consistent results. Comparing the proposed methods to the three conventional mechanisms, Table 12 provides the results. It may be seen from Table 12 that the range of the mean values is 0.922-0.977 when the temperature setting is 0.1, while the proposed approaches have a higher mean value range of 0.926-0.979, suggesting that the proposed approaches produce more consistent results than the conventional mechanisms. When the temperature setting is 0.3, the three conventional mechanisms have a mean value range of 0.892-0.956, while the proposed approaches (except Method 4) have a higher mean value range of 0.89-0.968.

TABLE 12

| | | 20 topic | |
|---|---|---|---|
| | | words + 4 docs | |
| Temperature | 20 topic words | (truncated) | 500 topic words |
| 0.1 | Mean: 0.922 | Mean: 0.966 | Mean: 0.977 |
| | Std Deviation: | Std Deviation: | Std Deviation: |
| | 0.034 | 0.008 | 0.009 |
| | Range: 0.133 | Range: 0.035 | Range: 0.03 |
| | Median: 0.924 | Median: 0.965 | Median: 0.978 |
| 0.3 | Mean: 0.892 | Mean: 0.956 | Mean: 0.942 |
| | Std Deviation: | Std Deviation: | Std Deviation: |
| | 0.032 | 0.008 | 0.016 |
| | Range: 0.146 | Range: 0.038 | Range: 0.065 |
| | Median: 0.89 | Median: 0.956 | Median: 0.946 |

In addition to the experiments above for the patent documents and Amazon.com® review documents, experiments were conducted to compare the speed and memory use of the proposed approach relative to the speed and memory use of the three conventional techniques (Top 20 topic terms, Top 20 topic terms+top 4 documents, Top 500 topic terms) mentioned above. The results are shown in Table 13 below:

TABLE 13

| | | | | | | Memory rss | Memory vmem |
|---|---|---|---|---|---|---|---|
| | Prompt count | | Output count | Speed | | (MB) | (MB) |
| B1 | 543 | token(s) | 869 token(s) | 20.338113354 | s | 4920.7 | 51781.2 |
| B2 | 29508 | token(s) | 607 token(s) | 61.490525059 | s | 4922.3 | 52025.3 |
| B3 | 8209 | token(s) | 458 token(s) | 22.98625412 | s | 4920.8 | 51904.4 |
| M1 | 552 | token(s) | 645 token(s) | 17.625621491 | s | 4920.7 | 51699.2 |
| M2 | 1255 | token(s) | 789 token(s) | 20.112551415 | s | 4920.7 | 51757.7 |
| M3 | 2279 | token(s) | 674 token(s) | 19.790437052 | s | 4921.9 | 51711.6 |
| M4 | 1084 | token(s) | 549 token(s) | 17.231746626 | s | 4921.5 | 51653.4 |

In Table 13 above, “B1” corresponds to the conventional Top 20 topic terms mechanism, “B2” corresponds to the conventional Top 20 topic terms+top 4 documents mechanism, “B3” corresponds to the conventional Top 500 topic terms mechanism, “M1” corresponds to Method 1 of the proposed approach, “M2” corresponds to Method 2 of the proposed approach, “M3” corresponds to Method 3 of the proposed approach, and “M4” corresponds to Method 4 of the proposed approach. “Speed” in Table 13 refers to the processing time to generate an output. RSS (Resident Set Size) memory in Table 13 above indicates the amount of memory a process occupies in the main memory. It provides a snapshot of the actual physical memory usage of a process. It is used for monitoring and optimizing system performance. A smaller value is desired. VMEM (Virtual Memory) memory in Table 13 combines a computer's RAM with temporary space on the hard disk to give an illusion of a large (virtual) memory. As seen from Table 13 above, all of the proposed methods M1-M4 are faster than all the conventional mechanisms, while consuming similar or lower memory than the conventional mechanisms. Methods 1-4 also have significantly lower token or similar counts in the prompt relative to all three conventional mechanisms.

### FIRST EXAMPLES

Example 1. A non-transitory computer-readable medium comprising computer-readable instructions stored thereon that when executed by a processor cause the processor to: receive a set of documents from which to generate a topic label and a topic description for a topic; input the set of documents into an unsupervised machine learning model; execute the unsupervised machine learning model to output the topic for the set of the documents, the topic comprising a plurality of topic terms; select a subset of topic documents from the set of documents, wherein the subset of topic documents belong to the topic and are selected based on the plurality of topic terms; input the subset of topic documents into an information extraction model; execute the information extraction model to generate a plurality of snippets from the subset of topic documents for the topic; generate a compressed representation of the set of documents based on the plurality of snippets to include in a prompt; input the prompt of the topic into a language model; and execute the language model based on the prompt to generate the topic label and the topic description for the topic.

Example 2. The non-transitory computer-readable medium of Example 1, wherein the unsupervised machine learning model is a topic model and the language model is a Large Language Model (LLM).

Example 3. The non-transitory computer-readable medium of Example 2, wherein the topic model is a Latent Dirichlet Allocation (LDA) clustering model or a Singular Value Decomposition (SVD) model.

Example 4. The non-transitory computer-readable medium of Example 1, wherein to generate the compressed representation of the set of documents based on the plurality of snippets, the computer-readable instructions further cause the processor to: rank the plurality of snippets based on a frequency of occurrence of each snippet of the plurality of snippets in the set of topic documents, wherein the higher the frequency of occurrence, the higher the rank of the snippet; and select a predetermined number of highest ranked snippets of the plurality of snippets to obtain a subset of snippets.

Example 5. The non-transitory computer-readable medium of Example 4, wherein to generate the compressed representation of the set of documents based on the plurality of snippets, the computer-readable instructions further cause the processor to concatenate the subset of snippets to generate a string for the topic.

Example 6. The non-transitory computer-readable medium of Example 5, wherein the prompt for the topic comprises the string for the topic, an output definition defining a format for the topic label and the topic description for the topic, and one or more constraints.

Example 7. The non-transitory computer-readable medium of Example 6, wherein the one or more constraints include a system role and a user role to provide a framework for how to generate the topic label and topic description for the topic.

Example 8. The non-transitory computer-readable medium of Example 7, wherein the one or more constraints further include a summary of what to include in the topic description.

Example 9. The non-transitory computer-readable medium of Example 6, wherein the format comprises: <topic number>: <topic label>: <topic description>.

Example 10. The non-transitory computer-readable medium of Example 1, wherein the information extraction model is a rule-based model.

Example 11. The non-transitory computer-readable medium of Example 1, wherein the information extraction model is a machine learning model trained for a specific domain or application or an extractive summarization model.

Example 12. The non-transitory computer-readable medium of Example 1, wherein the information extraction model is a combination of a rule-based model and one of a machine learning model trained for a specific domain or application or an extractive summarization model.

Example 13. The non-transitory computer-readable medium of Example 1, wherein the computer-readable instructions further cause the processor to: input the plurality of snippets into a Large Language Model (LLM); execute the LLM to generate a summary for each of the subset of topic documents from the plurality of snippets to obtain a plurality of summaries; and generate the prompt from the plurality of summaries.

Example 14. The non-transitory computer-readable medium of Example 1, wherein each snippet of the plurality of snippets includes a plurality of key words from the subset of topic documents, a plurality of key phrases from the subset of topic documents, or a combination of key words and key phrases from the subset of topic documents.

Example 15. The non-transitory computer-readable medium of Example 14, wherein each snippet of the plurality of snippets further includes context around at least one of one or more of the key words or one or more of the key phrases.

Example 16. A system comprising: a memory having computer-readable instructions stored thereon; and a processor that executes the computer-readable instructions to: receive a set of documents from which to generate a topic label and a topic description for a topic; input the set of documents into an unsupervised machine learning model; execute the unsupervised machine learning model to output the topic for the set of the documents, the topic comprising a plurality of topic terms; select a subset of topic documents from the set of documents, wherein the subset of topic documents belong to the topic and are selected based on the plurality of topic terms; input the subset of topic documents into an information extraction model; execute the information extraction model to generate a plurality of snippets from the subset of topic documents for the topic; generate a compressed representation of the set of documents based on the plurality of snippets to include in a prompt; input the prompt of the topic into a language model; and execute the language model based on the prompt to generate the topic label and the topic description for the topic.

Example 17. The system of Example 16, wherein the unsupervised machine learning model is a topic model, wherein the topic model is a Latent Dirichlet Allocation (LDA) clustering model or a Singular Value Decomposition (SVD) model, and wherein the language model is a Large Language Model (LLM).

Example 18. The system of Example 16, wherein to generate the compressed representation of the set of documents based on the plurality of snippets, the computer-readable instructions further cause the processor to: rank the plurality of snippets based on a frequency of occurrence of each snippet of the plurality of snippets in the set of topic documents, wherein the higher the frequency of occurrence, the higher the rank of the snippet; and select a predetermined number of highest ranked snippets of the plurality of snippets to obtain a subset of snippets.

Example 19. The system of Example 18, wherein to generate the compressed representation of the set of documents based on the plurality of snippets, the computer-readable instructions further cause the processor to concatenate the subset of snippets to generate a string for the topic.

Example 20. The system of Example 19, wherein the prompt for the topic comprises the string for the topic, an output definition defining a format for the topic label and the topic description for the topic, and one or more constraints, wherein the one or more constraints include a system role and a user role to provide a framework for how to generate the topic label and topic description for the topic, wherein the one or more constraints further include a summary of what to include in the topic description, and wherein the format comprises: <topic number>: <topic label>: <topic description>.

Example 21. The system of Example 16, wherein the information extraction model is at least one of (a) a rule-based model, or (b) one of a machine learning model trained for a specific domain or application or an extractive summarization model.

Example 22. The system of Example 16, wherein the computer-readable instructions further cause the processor to: input the plurality of snippets into a Large Language Model (LLM); execute the LLM to generate a summary for each of the subset of topic documents from the plurality of snippets to obtain a plurality of summaries; and generate the prompt from the plurality of summaries.

Example 23. The system of Example 16, wherein each snippet of the plurality of snippets includes a plurality of key words from the subset of topic documents, a plurality of key phrases from the subset of topic documents, or a combination of key words and key phrases from the subset of topic documents, and wherein each snippet of the plurality of snippets further includes context around at least one of one or more of the key words or one or more of the key phrases.

Example 24. A method comprising: receiving, by a processor executing computer-readable instructions stored on a memory, a set of documents from which to generate a topic label and a topic description for a topic; inputting, by the processor, the set of documents into an unsupervised machine learning model; executing, by the processor, the unsupervised machine learning model to output the topic for the set of the documents, the topic comprising a plurality of topic terms; selecting, by the processor, a subset of topic documents from the set of documents, wherein the subset of topic documents belong to the topic and are selected based on the plurality of topic terms; inputting, by the processor, the subset of topic documents into an information extraction model; executing, by the processor, the information extraction model to generate a plurality of snippets from the subset of topic documents for the topic; generating, by the processor, a compressed representation of the set of documents based on the plurality of snippets to include in a prompt; inputting, by the processor, the prompt of the topic into a language model; and executing, by the processor, the language model based on the prompt to generate the topic label and the topic description for the topic.

Example 25. The method of Example 24, wherein the unsupervised machine learning model is a topic model, wherein the topic model is a Latent Dirichlet Allocation (LDA) clustering model or a Singular Value Decomposition (SVD) model, and wherein the language model is a Large Language Model (LLM).

Example 26. The method of Example 24, wherein to generate the compressed representation of the set of documents based on the plurality of snippets, the method further comprises: ranking, by the processor, the plurality of snippets based on a frequency of occurrence of each snippet of the plurality of snippets in the set of topic documents, wherein the higher the frequency of occurrence, the higher the rank of the snippet; and selecting, by the processor, a predetermined number of highest ranked snippets of the plurality of snippets to obtain a subset of snippets.

Example 27. The method of Example 26, wherein to generate the compressed representation of the set of documents based on the plurality of snippets, the method further comprises concatenating, by the processor, the subset of snippets to generate a string for the topic, wherein the prompt for the topic comprises the string for the topic, an output definition defining a format for the topic label and the topic description for the topic, and one or more constraints, wherein the one or more constraints include a system role and a user role to provide a framework for how to generate the topic label and topic description for the topic, wherein the one or more constraints further include a summary of what to include in the topic description, and wherein the format comprises: <topic number>: <topic label>: <topic description>.

Example 28. The method of Example 24, wherein the information extraction model is at least one of (a) a rule-based model, or (b) one of a machine learning model trained for a specific domain or application or an extractive summarization model.

Example 29. The method of Example 24 further comprising: inputting, by the processor, the plurality of snippets into a Large Language Model (LLM); executing, by the processor, the LLM to generate a summary for each of the subset of topic documents from the plurality of snippets to obtain a plurality of summaries; and generating, by the processor, the prompt from the plurality of summaries.

Example 30. The method of Example 24, wherein each snippet of the plurality of snippets includes a plurality of key words from the subset of topic documents, a plurality of key phrases from the subset of topic documents, or a combination of key words and key phrases from the subset of topic documents, and wherein each snippet of the plurality of snippets further includes context around at least one of one or more of the key words or one or more of the key phrases.

### SECOND EXAMPLES

Example 1. A non-transitory computer-readable medium comprising computer-readable instructions stored thereon that when executed by a processor cause the processor to: receive a set of documents from which to generate a topic label and a topic description for a topic; input the set of documents into an unsupervised machine learning model; execute the unsupervised machine learning model to output the topic for the set of the documents, the topic comprising a plurality of topic terms; select a subset of topic documents from the set of documents, wherein the subset of topic documents belong to the topic and are selected based on the plurality of topic terms; identify a title from each of the subset of topic documents to obtain a plurality of titles; generate a compressed representation of the set of documents based on the plurality of titles to include in a prompt; input the prompt of each topic into a language model; and execute the language model based on the prompt to generate the topic label and the topic description for the topic.

Example 2. The non-transitory computer-readable medium of Example 1, wherein the unsupervised machine learning model is a topic model, and wherein the language model is a Large Language Model (LLM).

Example 3. The non-transitory computer-readable medium of Example 2, wherein the topic model is a Latent Dirichlet Allocation (LDA) clustering model or a Singular Value Decomposition (SVD).

Example 4. The non-transitory computer-readable medium of Example 1, wherein to generate the compressed representation of the set of documents based on the plurality of titles, the computer-readable instructions further cause the processor to concatenate the plurality of titles to generate a string for the topic.

Example 5. The non-transitory computer-readable medium of Example 4, wherein the prompt for the topic comprises the string for the topic, an output definition defining a format for the topic label and the topic description for the topic, and one or more constraints.

Example 6. The non-transitory computer-readable medium of Example 5, wherein the one or more constraints include a system role and a user role to provide a framework for how to generate the topic label and topic description for the topic.

Example 7. The non-transitory computer-readable medium of Example 6, wherein the one or more constraints further include a summary of what to include in the topic description.

Example 8. The non-transitory computer-readable medium of Example 5, wherein the format comprises: <topic number>: <topic label>: <topic description>.

Example 9. The non-transitory computer-readable medium of Example 1, wherein the title is identified from each of the subset of topic documents from metadata of each of the subset of topic documents.

Example 10. The non-transitory computer-readable medium of Example 1, wherein the title is identified from each of the subset of topic documents from a body of each of the subset of topic documents.

Example 11. The non-transitory computer-readable medium of Example 10, wherein the title is identified from a first sentence of a first a number of paragraphs in the body.

Example 12. The non-transitory computer-readable medium of Example 10, wherein the title is a first sentence of a topic document.

Example 13. The non-transitory computer-readable medium of Example 10, wherein to generate the title from the body of a topic document, the computer-readable instructions further cause the processor to: extract a first paragraph from the body of the topic document; input the first paragraph into a Large Language Model (LLM); and execute the LLM to generate the title.

Example 14. The non-transitory computer-readable medium of Example 10, wherein to generate the title from the body of a topic document, the computer-readable instructions further cause the processor to: extract a first line from the body of the topic document; input the first line into a Large Language Model (LLM); and execute the LLM to generate the title.

Example 15. The non-transitory computer-readable medium of Example 10, wherein to generate the title from the body of a topic document, the computer-readable instructions further cause the processor to: input the subset of topic documents into an information extraction model to generate a plurality of snippets; execute the information extraction model to generate the plurality of snippets; input the plurality of snippets into a Large Language Model (LLM); execute the LLM to generate a title for each of the subset of topic documents to obtain a plurality of titles; concatenate the plurality of titles to generate a title string; and generate the prompt from the title string.

Example 16. A system comprising: a memory having computer-readable instructions stored thereon; and a processor that executes the computer-readable instructions to: receive a set of documents from which to generate a topic label and a topic description for a topic; input the set of documents into an unsupervised machine learning model; execute the unsupervised machine learning model to output the topic for the set of the documents, the topic comprising a plurality of topic terms; select a subset of topic documents from the set of documents, wherein the subset of topic documents belong to the topic and are selected based on the plurality of topic terms; identify a title from each of the subset of topic documents to obtain a plurality of titles; generate a compressed representation of the set of documents based on the plurality of titles to include in a prompt; input the prompt of each topic into a language model; and execute the language model based on the prompt to generate the topic label and the topic description for the topic.

Example 17. The system of Example 16, wherein the unsupervised machine learning model is a topic model, wherein the topic model is a Latent Dirichlet Allocation (LDA) clustering model or a Singular Value Decomposition (SVD), and wherein the language model is a Large Language Model (LLM).

Example 18. The system of Example 16, wherein to generate the compressed representation of the set of documents based on the plurality of titles, the computer-readable instructions further cause the processor to concatenate the plurality of titles to generate a string for the topic.

Example 19. The system of Example 18, wherein the prompt for the topic comprises the string for the topic, an output definition defining a format for the topic label and the topic description for the topic, and one or more constraints, wherein the one or more constraints include a system role and a user role to provide a framework for how to generate the topic label and topic description for the topic and a summary of what to include in the topic description, and wherein the format comprises: <topic number>: <topic label>: <topic description>.

Example 20. The system of Example 16, wherein the title is identified from each of the subset of topic documents from metadata of each of the subset of topic documents.

Example 21. The system of Example 16, wherein the title is identified from each of the subset of topic documents from a body of each of the subset of topic documents.

Example 22. The system of Example 21, wherein the title is identified from a first sentence of a first a number of paragraphs in the body or a first sentence of a topic document.

Example 23. The system of Example 21, wherein to generate the title from the body of a topic document, the computer-readable instructions further cause the processor to: extract a first paragraph from the body of the topic document; input the first paragraph into a Large Language Model (LLM); and execute the LLM to generate the title.

Example 24. The system of Example 21, wherein to generate the title from the body of a topic document, the computer-readable instructions further cause the processor to: extract a first line from the body of the topic document; input the first line into a Large Language Model (LLM); and execute the LLM to generate the title.

Example 25. The system of Example 21, wherein to generate the title from the body of a topic document, the computer-readable instructions further cause the processor to: input the subset of topic documents into an information extraction model to generate a plurality of snippets; execute the information extraction model to generate the plurality of snippets; input the plurality of snippets into a Large Language Model (LLM); execute the LLM to generate a title for each of the subset of topic documents to obtain a plurality of titles; concatenate the plurality of titles to generate a title string; and generate the prompt from the title string.

Example 26. A method comprising: receiving, by a processor executing computer-readable instructions stored on a memory, a set of documents from which to generate a topic label and a topic description for a topic; inputting, by the processor, the set of documents into an unsupervised machine learning model; executing, by the processor, the unsupervised machine learning model to output the topic for the set of the documents, the topic comprising a plurality of topic terms; selecting, by the processor, a subset of topic documents from the set of documents, wherein the subset of topic documents belong to the topic and are selected based on the plurality of topic terms; identifying, by the processor, a title from each of the subset of topic documents to obtain a plurality of titles; generating, by the processor, a compressed representation of the set of documents based on the plurality of titles to include in a prompt; inputting, by the processor, the prompt of each topic into a language model; and executing, by the processor, the language model based on the prompt to generate the topic label and the topic description for the topic.

Example 27. The method of Example 26, wherein the unsupervised machine learning model is a topic model, and wherein the topic model is a Latent Dirichlet Allocation (LDA) clustering model or a Singular Value Decomposition (SVD), and wherein the language model is a Large Language Model (LLM).

Example 28. The method of Example 26, wherein to generate the compressed representation of the set of documents based on the plurality of titles, the computer-readable instructions further cause the processor to concatenate the plurality of titles to generate a string for the topic.

Example 29. The method of Example 28, wherein the prompt for the topic comprises the string for the topic, an output definition defining a format for the topic label and the topic description for the topic, and one or more constraints, wherein the one or more constraints include a system role and a user role to provide a framework for how to generate the topic label and topic description for the topic and a summary of what to include in the topic description, and wherein the format comprises: <topic number>: <topic label>: <topic description>.

Example 30. The method of Example 26, wherein the title is identified from each of the subset of topic documents from metadata of each of the subset of topic documents or from a body of each of the subset of topic documents.

The herein described subject matter illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents. The word “illustrative” is used herein to mean serving as an example, instance, or illustration. Any aspect or design described herein as “illustrative” is not necessarily to be construed as preferred or advantageous over other aspects or designs.

1. A non-transitory computer-readable medium comprising computer-readable instructions stored thereon that when executed by a processor cause the processor to:
receive a set of documents from which to generate a topic label and a topic description for a topic, wherein the topic label comprises a name for the topic and the topic description comprises a description of the topic in a human-understandable format;
input the set of documents into an unsupervised machine learning model;
execute the unsupervised machine learning model to output a plurality of topics for the set of the documents, each of the plurality of topics comprising a plurality of topic terms and each of the plurality of topic terms associated with a first weight value;
select a first subset of topic terms for each topic of the plurality of topics, wherein the first subset of topic terms for each topic are selected from the plurality of topic terms of that topic based on the first weight value assigned to each of the plurality of topic terms of that topic;
compute an inverse document frequency weight value for each topic term in the first subset of topic terms of each topic;
compute a second weight value for each topic term in the first subset of topic terms based on the first weight value and the inverse document frequency weight value for that topic term;
select a second subset of topic terms for each topic from the first subset of topic terms, wherein the second subset of topic terms are selected based on the second weight value of each topic term in the first subset of topic terms;
generate a compressed representation of the set of documents from the second subset of topic terms of each topic to include in a prompt for each topic, wherein the compressed representation having a first number of tokens to be stored in a computer memory that is less than a second number of tokens in the plurality of topic terms;
input the prompt of each topic into a language model; and
generate the topic label and topic description for each topic of the plurality of topics by executing the language model based on the prompt, the compressed representation being generated by concatenating the selected subset of topic terms and excluding unselected topic terms of the second number of tokens in the plurality of topic terms.

2. The non-transitory computer-readable medium of claim 1, wherein the unsupervised machine learning model is a topic model and the language model is a Large Language Model (LLM).

3. The non-transitory computer-readable medium of claim 2, wherein the topic model is a Latent Dirichlet Allocation (LDA) clustering model or a Singular Value Decomposition (SVD) model.

4. The non-transitory computer-readable medium of claim 1,
wherein the computer-readable instructions further cause the processor to compute the inverse document frequency weight value for each topic term using:
$$I D {F}_{topicterm} = log ( \frac{total number of topics}{number of topics containing the topicterm} )$$
where IDF_{topicterm} is the inverse document frequency weight value for a topic term of the plurality of topic terms of a topic, total number of topics is a number of the plurality of topics, and number of topics containing the topicterm is the number of the plurality of topics that have the topic term included in the plurality of topic terms.

5. The non-transitory computer-readable medium of claim 1, wherein to generate the compressed representation of the set of documents from the second subset of topic terms, the computer-readable instructions further cause the processor to concatenate the second subset of topic terms to generate a string for each topic.

6. The non-transitory computer-readable medium of claim 5, wherein the prompt for each topic comprises the string for that topic, an output definition defining a format for the topic label and the topic description for that topic, and one or more constraints.

7. The non-transitory computer-readable medium of claim 6, wherein the one or more constraints include a system role and a user role to provide a framework for how to generate the topic label and topic description for each topic.

8. The non-transitory computer-readable medium of claim 6, wherein the one or more constraints further include a summary of what to include in the topic description.

9. The non-transitory computer-readable medium of claim 6, wherein the format comprises: <topic number>: <topic label>: <topic description>.

10. The non-transitory computer-readable medium of claim 1, wherein the computer-readable instructions further cause the processor to compute the second weight value for each topic term in the first subset of topic terms of each topic by multiplying the first weight value of that topic term and the inverse document frequency weight value of that topic term.

11. The non-transitory computer-readable medium of claim 1, wherein a number of topic terms in the second subset of topic terms is less than the number of topic terms in the first subset of topic terms.

12. A non-transitory computer-readable medium comprising computer-readable instructions stored thereon that when executed by a processor cause the processor to:
receive a set of documents from which to generate a topic label and a topic description for a topic, wherein the topic label comprises a name for the topic and the topic description comprises a description of the topic in a human-understandable format;
input the set of documents into an unsupervised machine learning model;
execute the unsupervised machine learning model to output a plurality of topics for the set of the documents, each of the plurality of topics comprising a plurality of topic terms and each of the plurality of topic terms associated with a first weight value;
select a first subset of topic terms for each topic of the plurality of topics, wherein the first subset of topic terms for each topic are selected from the plurality of topic terms of that topic based on the first weight value assigned to each of the plurality of topic terms of that topic;
compute an inverse document frequency weight value for each topic term in the first subset of topic terms of each topic;
compute a second weight value for each topic term in the first subset of topic terms based on the first weight value and the inverse document frequency weight value for that topic term;
select a second subset of topic terms for each topic from the first subset of topic terms, wherein the second subset of topic terms are selected based on the second weight value of each topic term in the first subset of topic terms;
generate a compressed representation of the set of documents from the second subset of topic terms of each topic to include in a prompt for each topic, wherein the compressed representation having a first number of tokens to be stored in a computer memory that is less than a second number of tokens in the plurality of topic terms;
input the prompt of each topic into a language model; and
generate the topic label and topic description for each topic of the plurality of topics by executing the language model based on the prompt, the compressed representation being generated by concatenating the selected subset of topic terms and excluding unselected topic terms of the second number of tokens in the plurality of topic terms.

13. The non-transitory computer-readable medium of claim 12, wherein the unsupervised machine learning model is a topic model and the language model is a Large Language Model (LLM).

14. The non-transitory computer-readable medium of claim 13, wherein the topic model is a Latent Dirichlet Allocation (LDA) clustering model or a Singular Value Decomposition (SVD) model.

15. The system of claim 12, wherein the computer-readable instructions further cause the processor to compute the inverse document frequency weight value for each topic term using:
$$I D {F}_{topicterm} = log ( \frac{total number of topics}{number of topics containing the topicterm} )$$
where IDF_{topicterm} is the inverse document frequency weight value for a topic term of the plurality of topic terms of a topic, total number of topics is a number of the plurality of topics, and number of topics containing the topicterm is the number of the plurality of topics that have the topic term included in the plurality of topic terms.

16. The non-transitory computer-readable medium of claim 12, wherein to generate the compressed representation of the set of documents from the second subset of topic terms, the computer-readable instructions further cause the processor to concatenate the second subset of topic terms to generate a string for each topic.

17. The non-transitory computer-readable medium of claim 16, wherein the prompt for each topic comprises the string for that topic, an output definition defining a format for the topic label and the topic description for that topic, and one or more constraints.

18. The non-transitory computer-readable medium of claim 17, wherein the one or more constraints include a system role and a user role to provide a framework for how to generate the topic label and topic description for each topic.

19. The non-transitory computer-readable medium of claim 17, wherein the one or more constraints further include a summary of what to include in the topic description.

20. The non-transitory computer-readable medium of claim 17, wherein the format comprises: <topic number>: <topic label>: <topic description>.

21. The non-transitory computer-readable medium of claim 12, wherein the computer-readable instructions further cause the processor to compute the second weight value for each topic term in the first subset of topic terms of each topic by multiplying the first weight value of that topic term and the inverse document frequency weight value of that topic term.

22. The non-transitory computer-readable medium of claim 12, wherein a number of topic terms in the second subset of topic terms is less than the number of topic terms in the first subset of topic terms.

23. A method comprising:
receiving, by a processor executing computer-readable instructions stored on a memory, a set of documents from which to generate a topic label and a topic description for a topic, wherein the topic label comprises a name for the topic and the topic description comprises a description of the topic in a human-understandable format;
inputting, by the processor, the set of documents into an unsupervised machine learning model;
executing, by the processor, the unsupervised machine learning model for outputting a plurality of topics for the set of the documents, each of the plurality of topics comprising a plurality of topic terms and each of the plurality of topic terms associated with a first weight value;
selecting, by the processor, a first subset of topic terms for each topic of the plurality of topics, wherein the first subset of topic terms for each topic are selected from the plurality of topic terms of that topic based on the first weight value assigned to each of the plurality of topic terms of that topic;
computing, by the processor, an inverse document frequency weight value for each topic term in the first subset of topic terms of each topic;
computing, by the processor, a second weight value for each topic term in the first subset of topic terms based on the first weight value and the inverse document frequency weight value for that topic term;
selecting, by the processor, a second subset of topic terms for each topic from the first subset of topic terms, wherein the second subset of topic terms are selected based on the second weight value of each topic term in the first subset of topic terms;
generating, by the processor, a compressed representation of the set of documents from the second subset of topic terms of each topic to include in a prompt for each topic, wherein the compressed representation having a first number of tokens to be stored in a computer memory that is less than a second number of tokens in the plurality of topic terms;
inputting, by the processor, the prompt of each topic into a language model; and
generating, by the processor, the topic label and the topic description for each topic of the plurality of topics by executing the language model based on the prompt, the compressed representation being generated by concatenating the selected subset of topic terms and excluding unselected topic terms of the second number of tokens in the plurality of topic terms.

24. The system of claim 23, wherein the unsupervised machine learning model is a topic model and the language model is a Large Language Model (LLM).

25. The system of claim 24, wherein the topic model is a Latent Dirichlet Allocation (LDA) clustering model or a Singular Value Decomposition (SVD) model.

26. The method of claim 23, further comprising computing, by the processor, the inverse document frequency weight value for each topic term using:
$$I D {F}_{topicterm} = log ( \frac{total number of topics}{number of topics containing the topicterm} )$$
where IDF_{topicterm} is the inverse document frequency weight value for a topic term of the plurality of topic terms of a topic, total number of topics is a number of the plurality of topics, and number of topics containing the topicterm is the number of the plurality of topics that have the topic term included in the plurality of topic terms.

27. The system of claim 23, wherein to generate the compressed representation of the set of documents from the second subset of topic terms, the computer-readable instructions further cause the processor to concatenate the second subset of topic terms to generate a string for each topic.

28. The method of claim 27, wherein the prompt for each topic comprises the string for that topic, an output definition defining a format for the topic label and the topic description for that topic, and one or more constraints.

29. The method of claim 28, wherein the one or more constraints include at least one of (a) a system role and a user role to provide a framework for how to generate the topic label and topic description for each topic or (b) a summary of what to include in the topic description, and wherein the format comprises: <topic number>: <topic label>: <topic description>.

30. The method of claim 23, further comprising computing, by the processor, the second weight value for each topic term in the first subset of topic terms of each topic by multiplying, by the processor, the first weight value of that topic term and the inverse document frequency weight value of that topic term.
